(19) United States
(12) Patent Application Publication
(10) Pub. No.: US 2022/0374344 A1
(43) Pub. Date: Nov. 24, 2022

(54) TECHNIQUES FOR VISUAL SOFTWARE TEST MANAGEMENT

(71) Applicant: Infor (US), LLC, New York, NY (US)

(72) Inventor: Jeffrey Allen Brown, Colorado Springs, CO (US)

(21) Appl. No.: 17/328,851

(22) Filed: May 24, 2021

(51) Int. Cl. G06F 11/36

(52) U.S. Cl. CPC G06F 11/3688; G06F 11/3692; G06F 11/3684

(57) ABSTRACT

Various embodiments of the present invention address technical challenges related to software testing and make substantial technical improvements to improving the computational efficiency and operational reliability of test automation platforms, as well as to the operational reliability of software applications that are tested using the software application platforms. Various embodiments of the present invention provide methods, apparatuses, systems, computing devices, computing entities, and/or the like for performing efficient and techniques for visual software test management using captured test case data entities, annotation-based test case data entities, and dynamic test case data entity cloning.

### BACKGROUND

Various embodiments of the present invention address technical challenges related to software testing and make substantial technical improvements to improving the computational efficiency and operational reliability of test automation platforms, as well as to the operational reliability of software applications that are tested using the software application platforms.

### BRIEF SUMMARY

In general, embodiments of the present invention provide methods, apparatuses, systems, computing devices, computing entities, and/or the like for performing efficient and techniques for visual software test management using captured test case data entities, annotation-based test case data entities, and dynamic test case data entity cloning.

In accordance with one aspect, a method is provided. In one embodiment, the method comprises: generating, using one or more processors, a session data entity during a session of an end user, wherein: the session data entity comprises (a) an ordered sequence of a plurality of captured page images that (i) were captured during the session, and (ii) correspond to a plurality of webpages visited by the end user during the session, and (b) a plurality of captured user interactions performed by the end user interacting with the plurality of webpages, each captured user interaction is associated with a captured page image of the plurality of captured page images, each captured page image comprises one or more interactive page elements, and each captured user interaction corresponds to an interactive page element of the one or more interactive page elements in the captured page image; generating, using the one or more processors, the test case data entity based at least in part on the session data entity, wherein: the test case data entity comprises (i) a plurality of test case page images corresponding to the plurality of captured page images, and (ii) one or more test case steps associated with each of the plurality of test case page images, each test case step is associated with a captured user interaction of the plurality of captured user interactions, and generating each test case step is performed based at least in part on one or more action features of the captured user interaction that corresponds to the test case step; and providing access, using the one or more processors, to the test case data entity, wherein the test case data entity is configured to enable executing of one or more software testing operations using an automated testing workflow data object associated with the test case data entity.

In accordance with another aspect, a computer program product is provided. The computer program product may comprise at least one computer-readable storage medium having computer-readable program code portions stored therein, the computer-readable program code portions comprising executable portions configured to: receive, originating from a client computing entity, an ordered sequence of one or more test case step definitions for an input image, wherein each test case step definition is associated with (i) a visual element identifier location within the input image, and (ii) one or more action features; for each test case step definition, generate a test case step of an ordered sequence of test case step definitions based at least in part on the visual element identifier location for the test case step definition and the one or more action features for the test case step definition; generate, based at least in part on each test case step, a test case page image of one or more test case page images for the input image; generate the test case data entity based at least in part on the one or more test case page images; and provide access to the test case data entity, wherein the test case data entity is configured to enable execution of one or more software testing operations using an automated testing workflow data object associated with the test case data entity.

In accordance with yet another aspect, an apparatus comprising at least one processor and at least one memory including computer program code is provided. In one embodiment, the at least one memory and the computer program code may be configured to, with the processor, cause the apparatus to: receive, originating from a client computing entity, an ordered sequence of one or more test case step definitions for an input image, wherein each test case step definition is associated with (i) a visual element identifier location within the input image, and (ii) one or more action features; for each test case step definition, generate a test case step of an ordered sequence of test case step definitions based at least in part on the visual element identifier location for the test case step definition and the one or more action features for the test case step definition; generate, based at least in part on each test case step, a test case page image of one or more test case page images for the input image; generate the test case data entity based at least in part on the one or more test case page images; and provide access to the test case data entity, wherein the test case data entity is configured to enable execution of one or more software testing operations using an automated testing workflow data object associated with the test case data entity.

In accordance with one aspect, a method is provided. In one embodiment, the method comprises: receiving, using one or more processors and originating from a client computing entity, an ordered sequence of one or more test case step definitions for an input image, wherein each test case step definition is associated with (i) a visual element identifier location within the input image, and (ii) one or more action features; for each test case step definition, generating, using the one or more processors, a test case step of an ordered sequence of test case step definitions based at least in part on the visual element identifier location for the test case step definition and the one or more action features for the test case step definition; generating, using the one or more processors and based at least in part on each test case step, a test case page image of one or more test case page images for the input image; generating, using the one or more processors, the test case data entity based at least in part on the one or more test case page images; and providing access, using the one or more processors, to the test case data entity, wherein the test case data entity is configured to enable execution of one or more software testing operations using an automated testing workflow data object associated with the test case data entity.

In accordance with another aspect, a computer program product is provided. The computer program product may comprise at least one computer-readable storage medium having computer-readable program code portions stored therein, the computer-readable program code portions comprising executable portions configured to: receive, originating from a client computing entity, an ordered sequence of one or more test case step definitions for an input image, wherein each test case step definition is associated with (i) a visual element identifier location within the input image, and (ii) one or more action features; for each test case step definition, generate a test case step of an ordered sequence of test case step definitions based at least in part on the visual element identifier location for the test case step definition and the one or more action features for the test case step definition; generate, based at least in part on each test case step, a test case page image of one or more test case page images for the input image; generate the test case data entity based at least in part on the one or more test case page images; and provide access to the test case data entity, wherein the test case data entity is configured to enable execution of one or more software testing operations using an automated testing workflow data object associated with the test case data entity.

In accordance with yet another aspect, an apparatus comprising at least one processor and at least one memory including computer program code is provided. In one embodiment, the at least one memory and the computer program code may be configured to, with the processor, cause the apparatus to: receive, originating from a client computing entity, an ordered sequence of one or more test case step definitions for an input image, wherein each test case step definition is associated with (i) a visual element identifier location within the input image, and (ii) one or more action features; for each test case step definition, generate a test case step of an ordered sequence of test case step definitions based at least in part on the visual element identifier location for the test case step definition and the one or more action features for the test case step definition; generate, based at least in part on each test case step, a test case page image of one or more test case page images for the input image; generate the test case data entity based at least in part on the one or more test case page images; and provide access to the test case data entity, wherein the test case data entity is configured to enable execution of one or more software testing operations using an automated testing workflow data object associated with the test case data entity.

In accordance with one aspect, a method is provided. In one embodiment, the method comprises: generating, using one or more processors, one or more hashed representations of one or more webpages associated with the parent test case data entity, wherein each hashed representation is associated with the webpage; for each webpage: determining, using the one or more processors and based at least in part on whether the hashed representation for the webpage exists in a set of local hashed representations of a set of local test case page images in a local page library, whether the local page library comprises a target local test case page image of the set of local test case page images that is associated with the webpage, and in response to determining that the local page library comprises the target local test case page image, generating, using the one or more processors, a cloned reference to the target local test case page image for the webpage; generating, using the one or more process, a cloned test case data entity based at least in part on each cloned reference for a webpage; and providing access, using the one or more processors, to the cloned test case data entity, wherein the cloned test case data entity is configured to enable execution of one or more software testing operations using an automated testing workflow data object associated with the test case data entity.

In accordance with another aspect, a computer program product is provided. The computer program product may comprise at least one computer-readable storage medium having computer-readable program code portions stored therein, the computer-readable program code portions comprising executable portions configured to: generate one or more hashed representations of one or more webpages associated with the parent test case data entity, wherein each hashed representation is associated with the webpage; for each webpage: determine, based at least in part on whether the hashed representation for the webpage exists in a set of local hashed representations of a set of local test case page images in a local page library, whether the local page library comprises a target local test case page image of the set of local test case page images that is associated with the webpage, and in response to determining that the local page library comprises the target local test case page image, generate a cloned reference to the target local test case page image for the webpage; generate a cloned test case data entity based at least in part on each cloned reference for a webpage; and provide access to the cloned test case data entity, wherein the cloned test case data entity is configured to enable execution of one or more software testing operations using an automated testing workflow data object associated with the test case data entity.

In accordance with yet another aspect, an apparatus comprising at least one processor and at least one memory including computer program code is provided. In one embodiment, the at least one memory and the computer program code may be configured to, with the processor, cause the apparatus to: generate one or more hashed representations of one or more webpages associated with the parent test case data entity, wherein each hashed representation is associated with the webpage; for each webpage: determine, based at least in part on whether the hashed representation for the webpage exists in a set of local hashed representations of a set of local test case page images in a local page library, whether the local page library comprises a target local test case page image of the set of local test case page images that is associated with the webpage, and in response to determining that the local page library comprises the target local test case page image, generate a cloned reference to the target local test case page image for the webpage; generate a cloned test case data entity based at least in part on each cloned reference for a webpage; and provide access to the cloned test case data entity, wherein the cloned test case data entity is configured to enable execution of one or more software testing operations using an automated testing workflow data object associated with the test case data entity.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2A provides an example web server computing entity in accordance with some embodiments discussed herein;

FIG. 2B provides an example client computing entity in accordance with some embodiments discussed herein;

FIG. 3 provides an exemplary diagram of a test case manager module that can be used to practice embodiments discussed herein;

FIGS. 4A-4F provide operational examples of various test case user visualization interfaces in accordance with some embodiments discussed herein;

FIG. 5 is a flowchart diagram of an example process for generating a test case data entity based at least in part on a session data entity in accordance with some embodiments discussed herein;

FIG. 6 provides an operational example of initiating a captured session in accordance with some embodiments discussed herein;

FIGS. 7A-7C depict an operational example of a captured session in accordance with some embodiments discussed herein;

FIG. 8 provides an operational example of a test case visualization user interface for a test case data entity that is generated based at least in part on a session data entity in accordance with some embodiments discussed herein;

FIG. 9 is a flowchart diagram of an example process for generating a test case data entity based at least in part on an input image in accordance with some embodiments discussed herein;

FIG. 10 depicts an operational example of uploading an input image in accordance with some embodiments discussed herein;

FIGS. 11A-11B depict an operational example of user operations defining an ordered sequence of test case step definitions in accordance with some embodiments discussed herein;

FIG. 12 is a flowchart diagram of an example process for dynamically cloning a parent test case data entity into a local test case library in accordance with some embodiments discussed herein;

FIG. 13 is a flowchart diagram of an example process for generating a cloned test case data entity based at least in part on a parent test case data entity in accordance with some embodiments discussed herein;

FIG. 14 provides an operational example of a test case visualization user interface that depicts a test case record for a cloned test case data entity in accordance with some embodiments discussed herein;

FIG. 15 is a flowchart diagram of an example process for modifying a test case data entity by integrating a test case page image for a new webpage in accordance with some embodiments discussed herein;

FIG. 16 is a flowchart diagram of an example process for modifying a test case data entity by integrating a nestable test case data entity in accordance with some embodiments discussed herein;

FIG. 17 is a flowchart diagram of an example process for modifying a cloned test case data entity by integrating one or more test case page images determined based at least in part on a session data entity into a test case data entity in accordance with some embodiments discussed herein;

FIG. 18 is a flowchart diagram of an example process for publishing a local test case data entity to a parent test case library in accordance with some embodiments discussed herein;

FIG. 19 is a flowchart diagram of an example process for modifying a test case data entity by associating a test case step with an interactive page element in accordance with some embodiments discussed herein;

FIG. 20 provides an operational example of a test case visualization user interface for a cloned test case data entity in accordance with some embodiments discussed herein;

FIG. 21 is a flowchart diagram of an example process for generating a session data entity in accordance with some embodiments discussed herein;

FIG. 22 provides an operational example of a test case version control user interface in accordance with some embodiments discussed herein;

FIGS. 23A-23B provide operational examples of a test case visualization user interface with a test case page image search output and a nestable test case search output respectively in accordance with some embodiments discussed herein; and

FIGS. 24A-24B provide operational examples of a set of capture mode operations in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### Overview and Technical Advantages

Provided below are techniques for generating test case data entities based at least in part on session data entities, generating test case data entities based at least in part on user-provided images, and generating test case data entities based at least in part on test case data entity cloning operations. Each of the noted techniques is configured to provide test case generation techniques that are more user-friendly and intuitive. The user-friendly and intuitive test case generation techniques enhance the accuracy and reliability of test case data entities generated by test case developers, which in turn reduces the number of erroneous testing operations (e.g., erroneous automated testing operations) that are performed.

For example, in some embodiments, a test case can be documented with the same speed as the speed of performing the test case steps within a software application, which in turn increases the speed of creating test cases and reduces the chance of accidentally leaving a test case step out of a test case. As another example, in some embodiments, test case documentation data can be visually recorded, which in turn significantly reduces the chance of accidentally leaving a test case step out of a test case. In this way, various embodiments of the present invention increase the speed, accuracy, and reliability of generating test cases relative to various existing software testing frameworks. As an example of the discussed features of various embodiments of the present invention, while with most software testing frameworks users need to document logging in as the first step of an exemplary test case, various embodiments of the present invention enable a software testing framework that enables capturing the values typed in to each field and the actions associated with the login process. In some embodiments, accuracy and reliability are byproducts of the efficiency gains of the intuitive nature of the software testing framework enabled by various embodiments of the present invention which almost eliminates the need to train new users on how to use the software testing framework.

Reducing the number of erroneous testing operations improves the operational efficiency of test automation platforms by reducing the number of processing operations that need to be performed by the noted test automation platforms in order to enable software testing operations (e.g., automated software testing operations). By reducing the number of processing operations that need to be performed by the noted test automation platforms in order to enable software testing operations, various embodiments of the present invention make important technical contributions to the field of software application testing.

Furthermore, by enhancing the accuracy and reliability of test case data entities generated by test case developers, the user-friendly and intuitive test case generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

Moreover, various embodiments of the present invention address technical challenges associated with efficiently and effectively generating and visualizing software testing operations. Various existing software testing solutions are not user-friendly and require high technical software knowledge and intimate familiarity with the software being tested. Furthermore, various existing software testing solutions do not operate in visually intuitive forms. To address the noted efficiency and effectiveness challenges associated with various existing software testing solutions, various embodiments of the present disclosure describe software testing operations related to generating and/or modifying test case data entities in a visual and user-friendly manner.

Various embodiments of the present disclosure also utilize a multi-tenant cloud architecture (e.g., a Software-as-a-Service (SaaS) architecture) allowing multiple clients to utilize the test automation platform enabled by the embodiments of the present disclosure and to share software testing operations between themselves. In doing so, various embodiments of the present invention address technical challenge associated with efficiency and reliability of various software testing solutions. In some embodiments, the multi-tenant cloud architecture enables sharing platform costs across multiple clients, thereby reducing costs of a test automation platform, which, in conventional test automation platforms, are very expensive. By allowing customers to share the burden of platform costs, various embodiments of the present invention reduce the overall cost for the parties who interact/utilize a test automation platform.

### Definitions of Certain Terms

The term “test case data entity” may refer to an electronically-stored data construct that is configured to describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, and/or the like) associated with a corresponding test case. In some embodiments, a test case data entity is configured to describe: (i) one or more test case page images associated with the test case, and (ii) for each test case page image of the one or more test case page images, a set of test case steps (e.g., an ordered set of test case steps) that relate to the test case page image. In some embodiments, the test case data entity contains data that can be used to generate a test case visualization user interface for the test case associated with the test case data entity, such as a test case visualization user interface that depicts: (i) one or more test case page images associated with the test case, and (ii) for each test case page image of the one or more test case page images, a set of test case visualizations corresponding to each test case step in the set of test case steps that relate to the particular test case page image.

The term “test case page image” may refer to an electronically-stored data construct that is configured to describe an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded image and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

The term “test case step” may refer to an electronically-stored data construct that is configured to describe a user action required by a test associated with a corresponding test case data entity, where the user action may be performed with respect to an interactive page element of a webpage associated with a test case page image of the corresponding test case data entity. In some embodiments, a test case step may include data used to generate at least one of the following: (i) a visual element identifier overlaid on the test case page image in an overlay location associated with a region of the test case page image that corresponds to the interactive page element for the test case step, and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action, (ii) a user input value of the user action that may describe a value of a user action with respect to an interactive page element, (iii) a user action sequence identifier of the user action that may describe a temporal order of the user action within a set of sequential user actions performed with respect to interactive page elements of a webpage associated with the user action, and (iv) a user action time of the user action that may describe a captured time of the corresponding user action, and/or the like.

The term “webpage” may refer to a collection of data provided by a website and displayed to an end user via a web browser application. As described herein, a set of webpages may include different webpages displayed sequentially within a single web browser application tab and/or different webpages displayed across two or more web browser application tabs.

The term “session data entity” may refer to an electronically-stored data construct that is configured to describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and dragging an icon on the second webpage from a first location to a second location. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured, and (ii) for each webpage of the sequence of webpages, a set of user interactions performed in relation to the noted webpage. For example, for the exemplary session data entity described above, the session data entity may describe: (i) a sequence of webpages that describes that the first webpage was visited first and the second webpage was subsequently visited, (ii) for the first webpage, the user interactions corresponding to entering a text input in the first designated textbox on the first webpage, selecting the first designated checkbox on the first webpage, and selecting the first designated button on the first webpage, and (iii) for the second webpage, the user interactions corresponding to selecting the first designated radio button from the first designated set of related radio buttons on the second webpage and dragging and dropping the icon on the second webpage. In some embodiments, the session data entity comprises (a) an ordered sequence of a plurality of captured page images that (i) were captured during the session, and (ii) correspond to a plurality of webpages visited by the end user during the session, and (b) a plurality of captured user interactions performed by the end user while interacting with the plurality of webpages. In some embodiments, to generate a session data entity, a screen capture component collects the various metadata for each interactive page element, such as element ID, element parent ID, element sibling IDs, the absolute and relative xpath of the element, the element name, the element type, etc., where at least some of these metadata features may be used create multiple strategies which can be used to locate the interactive page element upon playback of the session data entity.

The term “captured page image” may refer to an electronically-stored data construct that is configured to describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are performed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are performed. In some embodiments, screen captures corresponding to captured page images are stored by reference within a relational database, so if a user updates or replaces a captured page image used in one test case data entity, say the test case data entity that corresponds to a login page, that updated captured page image will be reflected across all other test case data entities that use that same captured page image. This leads to a significant productivity gain as, without this feature, the user would have to locate, edit, and update each test case data entity that also uses this same captured page.

The term “captured user interaction” may refer to an electronically-stored data construct that is configured to describe a recorded/captured user action with respect to a segment of a webpage, where the captured user interaction may be described by a session data entity corresponding to a recorded/captured session that included performing the corresponding user action associated with the captured user interaction. In some embodiments, a captured user interaction describes: (i) an associated interactive page element within a corresponding webpage with respect to which the corresponding user action was performed during the recorded/captured session, (ii) a user action type of the corresponding user action with respect to the associated interactive page element within the corresponding webpage, and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction, and (ii) selecting (i.e., clicking) as the user action type of the captured user interaction. As another example, consider a recorded/captured session that included the user action of typing “pshoghi” into a username textbox. In the noted example, the captured user interaction corresponding to the noted user action may describe: (i) the username textbox as the interactive page element corresponding to the captured user interaction, (ii) typing (i.e., inputting text) as the user action type corresponding to the captured user interaction, and (iii) because the user action type of typing requires a user input value, the text input value “pshoghi” as the user input value for the captured user interaction. In some embodiments, a captured user interaction is associated with (i) a captured page image, (ii) an interactive page element, and (ii) a set of action features. The captured page image for a captured user interaction may describe an image of a corresponding webpage with respect to which a user action corresponding to the captured user interaction is performed, while an interactive page element may describe an element (e.g., an interactive page element, a Hypertext Markup Language (HTML) element, and/or the like) of the corresponding webpage, where the user action corresponding to the captured user interaction is performed exclusively by changing a state and/or a value of the particular element. An action feature of a captured user interaction may describe any property of a user action intended to change a state and/or a value of an interactive page element, where the user action is recorded/captured using a captured user interaction in a session data entity. Examples of action features for a captured user interaction include (i) a user action type of a user action associated with the captured user interaction that may describe a general mode of user interaction with an interactive page element which may be defined based at least in part on an interactive page element type of the interactive page element, (ii) a user input value of a user action associated with the captured user interaction that may describe a finalized (rather than intermediate) value of a user action with respect to an interactive page element, (iii) a user action sequence identifier of a user action associated with the captured user interaction that may describe a temporal order of the user action within a set of sequential user actions performed with respect to interactive page elements of a webpage associated with the user action, (iv) a user action time of a user action associated with the captured user interaction that may describe a captured time of the corresponding user action, and/or the like. In some embodiments, a captured user action may only be generated upon detecting a qualified user action from a set of qualified user actions (e.g., a set that may exclude at least one of the click action on the field, the shift+key action for upper case, and the field leave action).

The term “test case step definition” may refer to an electronically-stored data construct that is configured to describe user-provided values for (i) the location of a visual element identifier for a test case step that is overlaid on an input image, and (ii) one or more action features for a user action associated with the test case step, where both the location of the visual element identifier for the test case step and the one or more action features for the user action are determined based at least in part on values explicitly provided by an end user (rather than based at least in part on monitoring a session associated with the end user). Therefore, a test case step definition may be generated based at least in part on explicit test case step data provided by an end user, as opposed to inferred based at least in part on a session data entity. A test case step definition may be associated with a position in an ordered sequence of test case step definitions associated with a corresponding image, where the position of a test case step definition within the noted ordered sequence may be determined based at least in part on a user action sequence identifier of the user action that is associated with the test case step for the test case step definition.

The term “parent test case data entity” may refer to an electronically-stored data construct that is configured to describe a test case data entity stored on a parent test case library that is cloned into a local test case library. The parent test case data entity may, in some embodiments, comprises a set of references to a set of source test case page images, where each source test case page image may in some cases be associated with a hashed representation of an address identifier of the corresponding webpage associated with the source test case page image. In some embodiments, if a parent test case data entity is associated with a set of captured page images and a set of uploaded input images, then the set of captured images may be associated with hashed representations of their corresponding address identifiers. In some of the noted embodiments, the parent test case data entity may include a reference to each test case page image associated with the parent test case data entity, including both to the set of captured page images and the set of uploaded images. For example, consider a parent test case data entity that is associated with captured page images C1 and C2 that are associated with webpages W1 and W2 as well as the uploaded image I1. In the noted example, the parent test case data entity may include (i) references to C1, C2, and I1, and (ii) hashed representations of address identifiers (e.g., URLs) of W1 and W2.

The term “cloned test case data entity” may refer to an electronically-stored data construct that is configured to describe a test case data entity that is generated based at least in part on integrating a parent test case data entity into a local test case library. In some embodiments, a cloned test case data entity that is generated based at least in part on a parent test case data entity comprises, for each test case page image of the parent test case data entity whose corresponding hashed representation is found among the hashed representations of a group of local test case page images in a local page image repository of the local test case library, the reference to a local test case page image in the local page image repository whose hashed representation corresponds to the hashed representation of the test case page image in the parent test case data entity. For example, consider an exemplary parent test case data entity that includes a first test case page image T1 that is associated with the hashed representation H1, a second test case page image T2 that is associated with the hashed representation H2, and a third test case page image that is not associated with a hashed representation. In the noted examples, if the local page image repository for the local test case library includes a test case page image D1 that corresponds to the hashed representation H1 but does not include any test case page images that correspond to the hashed representation H2, then the cloned test case data entity may include a reference to D1 for the webpage corresponding to the hashed representation H1 but no references for the webpage corresponding to the hashed representation H2. In some embodiments, a cloned test case data entity comprises (i) for each test case page image of the parent test case data entity whose hashed representation corresponds to the hashed representation of at least one test case page image in a local page image repository, the at least one test case page image and masked test case step values described by the parent test case data entity for the test case page image of the parent test case data entity, and (ii) for each test case page image of the parent test case data entity whose hashed representation does not correspond to the hashed representation of at least one test case page image in a local page image repository, a null/blank image and masked test case step values (e.g., cleared/removed test case step values) described by the parent test case data entity for the test case page image of the parent test case data entity. In some embodiments, a masked test case step is a test case step that is modified in accordance with one or more data masking operations, where defined categories of data associated with the test case step (e.g., the user input value for the test case step) have been removed and/or rendered inaccessible as a result of the noted one or more data masking operations.

The term “nestable test case data entity” may refer to an electronically-stored data construct that is configured to describe a test case data entity that can be integrated as a unit within another test case data entity, where any modifications of the nestable test case data entity causes corresponding modifications for any test case data entity that has integrated the nestable test case data entity. In some embodiments, a nestable test case data entity may describe a sequence of test case page images each potentially associated with a set of test case steps. An example of a nestable test case data entity is a business function (i.e., a set of repeatable actions that may be used to describe a series of static actions within the scope of multiple test scenarios) that describes test case steps associated with a test for logging into a software system using particular authentication credentials. In some embodiments, a nestable test case data entity may itself include one or more nestable test case data entities.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more some embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Framework

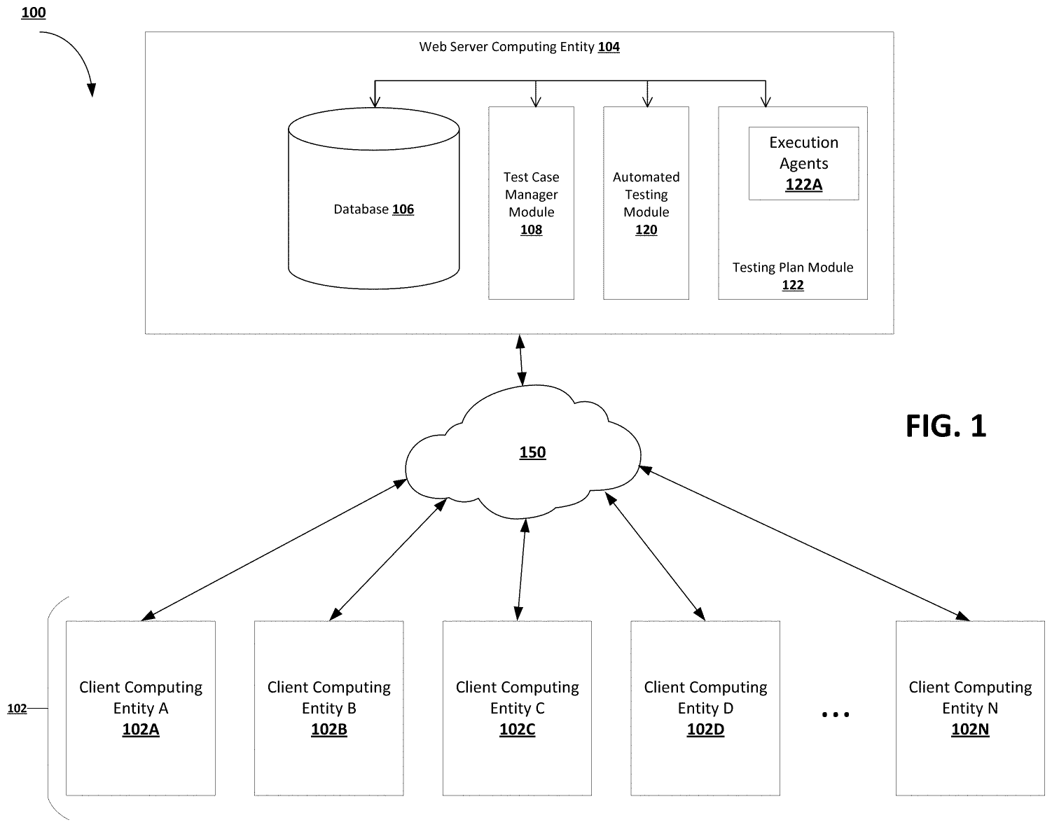

FIG. 1 is a schematic diagram of an example system architecture 100 for visually documenting a software testing operation and generating a test case data entity. The system architecture 100 comprises a plurality of client computing entities 102 and a multi-tenant cloud architecture characterized by a web server computing entity 104, where the web server computing entity 104 comprises a database 106, a test case manager module 108, an automated testing module 120, and an testing plan module 122.

In some embodiments, the web server computing entity 104 may be made available as a “Software-as-a-Service” framework to multiple end users through the multi-tenant cloud architecture. In some embodiments, the multiple end users may each use a client computing entities 102A-N to connect (through the web server computing entity 104) to the multi-tenant cloud architecture to cause performance of one or more software testing operations associated with the web server computing entity 104. The web server computing entity 104 may allow communication between client computing entities 102A-N via one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The web server computing entity 104 may be configured to enable generating visual documentation for a software testing operation. The visual documentation for a software testing operation may be referred to as a “test case data entity” herein. The web server computing entity 104 may be further configured to enable modifying test case data entities, integrating test case data entities across test case libraries, manually executing test case data entities, automatically executing automation scripts corresponding to test case data entities, and/or the like.

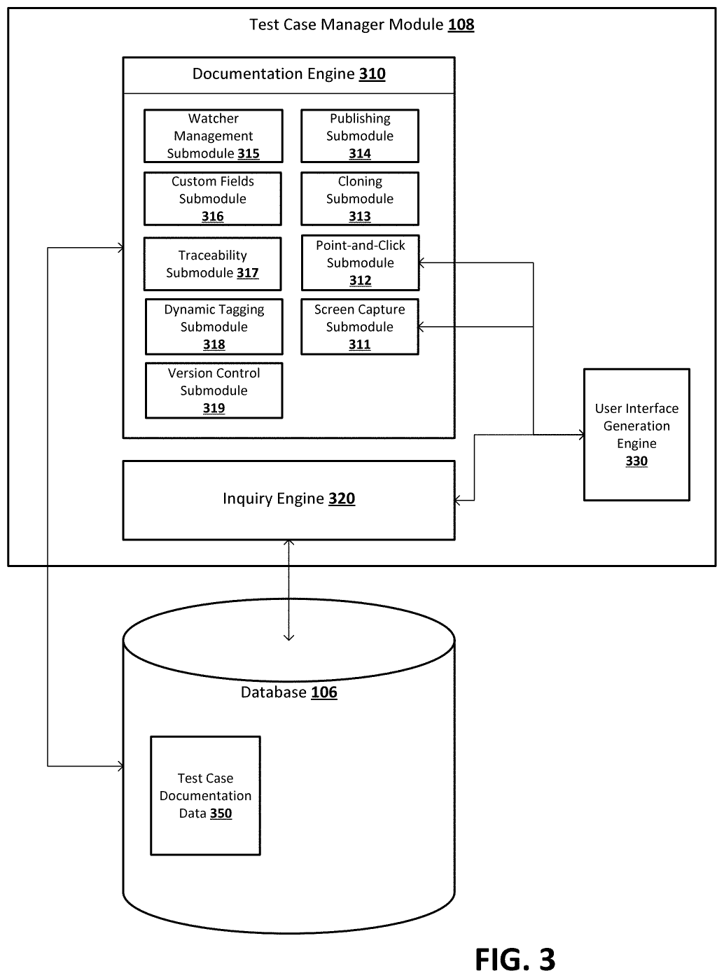

The test case manager module 108 may enable generating test case data entities, modifying test case data entities, and integrating test case data entities across test case libraries. An operational example of the software architecture for the test case manager module 108 is depicted in FIG. 3.

As depicted in FIG. 3, the test case manager module 108 includes: (i) a documentation engine 310 that is configured to generate and maintain test case documentation data 350 including test case data entities, test case page images, test case steps, test case watcher data, test case traceability data, test case tagging data, and/or the like; (ii) an inquiry engine 320 that is configured to process queries related to the test case documentation data 350 in accordance with defined query criteria to generate test case visualization data as query results; and (iii) a user interface generation engine 330 that is configured to generate test case visualization user interface data based at least in part on test case visualization data.

In some embodiments, the inquiry engine 320 is configured to (i) receive requests for querying test case documentation data 350 from the user interface generation engine 330, (ii) process the requests to generate test case visualization data as query results, and (iii) provide the test case visualization data to the user interface generation engine 330. Examples of query types presented to the inquiry engine 320 include (i) requests for accessing/modifying a test case data entity, (ii) requests for accessing/modifying a test case page image, (iii) requests for accessing/modifying a test case step, (iv) requests for accessing/modifying test case traceability data, (v) requests for accessing/modifying test case watcher management data, (vi) accessing/modifying test case custom field data, (vii) accessing/modifying test case dynamic tagging data, (viii) requests for cloning a parent test case data entity from a parent test case library to a local test case library, (ix) requests for publishing a local test case data entity from a local test case library to a parent test case library, and (vi) request for accessing/creating/modifying user approvals and electronic signatures.

In some embodiments, the user interface generation engine 330 is configured to (i) receive end user queries in relation to test case documentation data 350, (ii) provide the end user queries to the inquiry engine 320, (iii) receive test case visualization data from the inquiry engine 320 in response to the end user queries, (iv) generate user interface data based at least in part on the test case visualization data, and (v) provide the user interface data to a client computing entity 102. As described above, examples of query types presented to the inquiry engine 320 include (i) requests for accessing/modifying a test case data entity, (ii) requests for accessing/modifying a test case page image, (iii) requests for accessing/modifying a test case step, (iv) requests for accessing/modifying test case traceability data, (v) requests for accessing/modifying test case watcher management data, (vi) accessing/modifying test case custom field data, (vii) accessing/modifying test case dynamic tagging data, (viii) requests for cloning a parent test case data entity from a parent test case library to a local test case library, (ix) requests for publishing a local test case data entity from a local test case library to a particular parent test case library, and (vi) request for accessing/creating/modifying user approvals and electronic signatures.

The automated testing module 120 may be configured to enable generating an automated testing workflow data object based at least in part on a test case data entity, where the automation workflow may be executed by an execution plan generated using the testing plan module 122 in accordance with the execution parameters (e.g., execution environments) defined by the execution plan and using the execution agents 122A of the testing plan module 122. The testing plan module 122 may further be configured to enable manual execution of a test case corresponding to a test case data entity and/or manual execution of an automation workflow.

The multi-tenant cloud architecture of web server computing entity 104 may enable communication between the automated testing module 120, the testing plan module 122, and the database 106. In embodiments, the database 106 may be a relational database. The database 106 may store test case data entities, which may further be retrieved, edited, and saved by web server computing entity 104. The database 106 may be partitioned into a plurality of libraries. It will be appreciated that in a multi-tenant cloud architecture, the database 106 may be partitioned to allow for secure use by the plurality of client computing entities 102; that is, each client computing entity 102 may securely view, edit, save, and/or perform other operations on their own data in the database 106 without other client computing entities 102 being able to perform the same such actions. For example, the database 106 may comprise a plurality of user libraries A-N, each corresponding to a N number of end users. The database 106 may prevent communication, or transfer of data, between any user libraries A-N. The database 106 may further comprise one or more common-access libraries. While data within each user library may be restricted to other end users, the one or more common-access libraries may allow an end user to “publish” their own data for other end users to view. Likewise, the one or more common-access libraries may allow an end user to “clone” shared data in the one or more common-access libraries to their own corresponding user library to edit and perform other such operations. In some embodiments, the one or more common-access libraries may comprise a shared library and a host library, each with different end user permissions. For example, a host library may only allow a specific end user or a specific group of end users to publish their data, whereas a shared library may allow all end users or at least a greater number of end users to publish their data.

The database 106 may include one or more storage units, such as multiple distributed storage units that are connected through a computer network. The database 106 may store data using one or more non-volatile storage or memory median including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Web Server Computing Entity

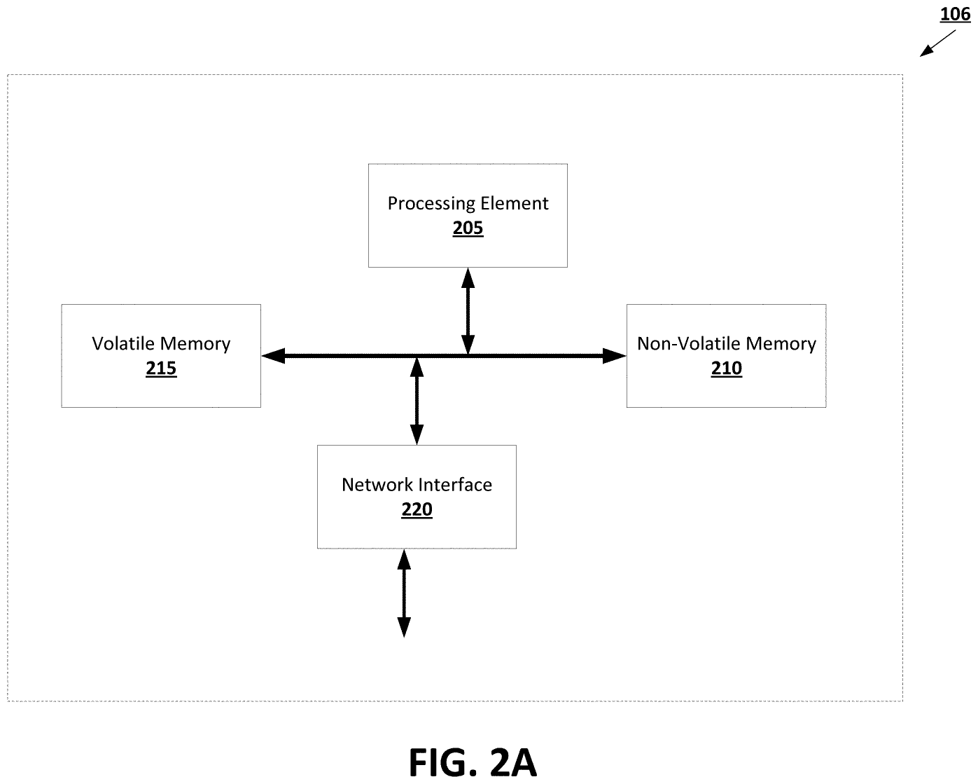

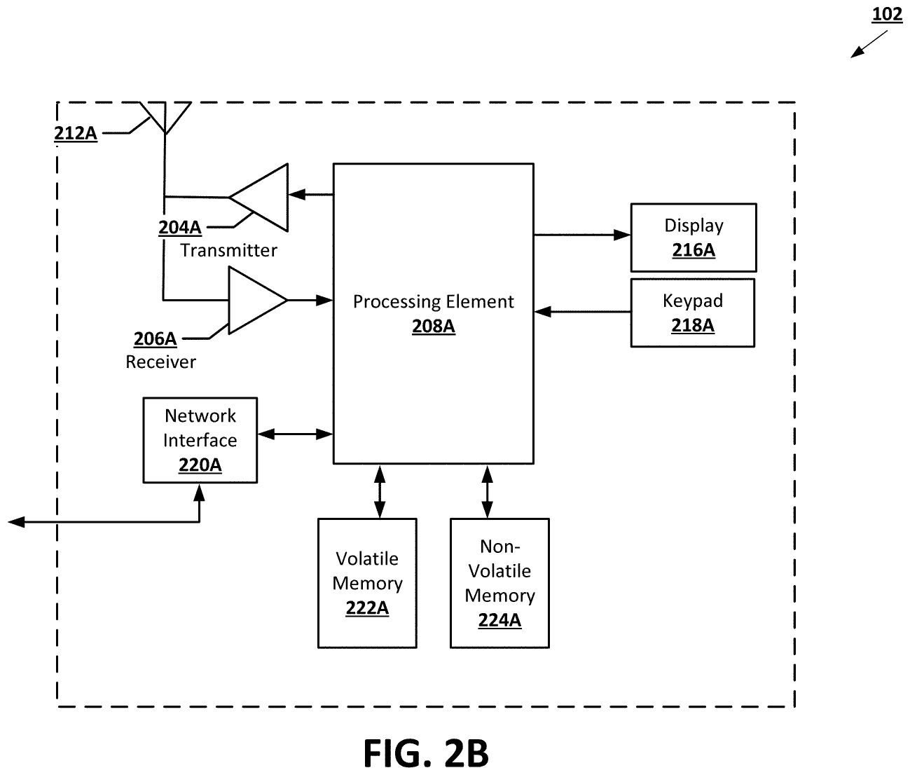

FIG. 2A provides a schematic of a web server computing entity 104 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the web server computing entity 104 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 104 may include, or be in communication with, one or more processing elements 205 (also referred to as processors, processing circuitry, and/or similar terms used herein interchangeably) that communicate with other elements within the web server computing entity 104 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the web server computing entity 104 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the web server computing entity 104 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 104 with the assistance of the processing element 205 and operating system.

As indicated, in one embodiment, the web server computing entity 104 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 104 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 104 may include, or be in communication with, one or more input elements, such as a keyboard input, a mouse input, a touch screen/display input, motion input, movement input, audio input, pointing device input, joystick input, keypad input, and/or the like. The web server computing entity 104 may also include, or be in communication with, one or more output elements (not shown), such as audio output, video output, screen/display output, motion output, movement output, and/or the like.

### Exemplary Client Computing Entity

FIG. 2B provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 212A, a transmitter 204A (e.g., radio), a receiver 206A (e.g., radio), and a processing element 208A (e.g., CPLDs, microprocessors, multi-core processors, coprocessing entities, ASIPs, microcontrollers, and/or controllers) that provides signals to and receives signals from the transmitter 204A and receiver 206A, correspondingly.

The signals provided to and received from the transmitter 204A and the receiver 206A, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 104. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 104 via a network interface 220A.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 216A coupled to a processing element 208A) and/or a user input interface (coupled to a processing element 208A). For example, the user interface may be a user application, browser, user interface, and/or similar words used herein interchangeably executing on and/or accessible via the client computing entity 102 to interact with and/or cause display of information/data from the web server computing entity 104, as described herein. The user input interface can comprise any of a number of devices or interfaces allowing the client computing entity 102 to receive data, such as a keypad 218A (hard or soft), a touch display, voice/speech or motion interfaces, or other input device. In embodiments including a keypad 218A, the keypad 218A can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 222A and/or non-volatile storage or memory 224A, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 104 and/or various other computing entities.

In another embodiment, the client computing entity 102 may include one or more components or functionality that are the same or similar to those of the web server computing entity 104, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Local, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary Test Case Manager Module

FIG. 3 provides an illustrative schematic representative of a test case manager module 108 that can be used in accordance with various embodiments of the present invention. In some embodiments, the web server computing entity 104 may be a part of the multi-tenant cloud architecture and used by multiple end users via client computing entities 102. As shown in FIGS. 1 and 3, the web server computing entity 104 may be in communication (e.g., via a communication network, a hardware bus, and/or the like) with a web server computing entity 104 and a database 106. Given that the web server computing entity 104 may exist within a multi-tenant cloud architecture, the web server computing entity 104 may be configured to operate on a different computing entity, processor, processor core, and/or processing thread from other system modules such as the automated testing module 120 and the testing plan module 122.

As illustrated in FIG. 3, communication between web server computing entity 104 and the web server computing entity 104 may comprise communications between web server computing entity 104 and a user interface generation engine 330 within the web server computing entity 104. The user interface generation engine 330 may be configured to receive data from web server computing entity 104 to generate a user interface on one or more client computing entities 102. Moreover, the user interface generation engine 330 and/or the web server computing entity 104 may be configured to send data to the documentation engine 310, such as input commands from a user interface of a client computing entities 102.

The web server computing entity 104 may comprise an inquiry engine 320, which may be configured to locate and retrieve test case documentation data 350 from the database 106. The inquiry engine 320 may be configured to locate and retrieve test case documentation data 350 from the database 106 based at least in part on query criteria and/or other input received by the web server computing entity 104. For example, the web server computing entity 104 may forward query criteria inputted via a user interface of a client computing entity 102, and the inquiry engine 320 may return one or more test case documentation data 350 that satisfy the search criteria.

The test case manager module 108 may further comprise a documentation engine 310. The documentation engine 310 may be configured to perform various operations such as generating a test case data entity, editing a test case data entity, visualizing a test case data entity, and/or the like. The documentation engine 310 may be in communication (e.g., via a communication network or a hardware bus) with the inquiry engine 320, such as by specifying a specific test case data entity for which the documentation engine 310 may perform operations. The documentation engine 310 may further be in communication (e.g., via a communication network or a hardware bus) with the database 106, for example to perform operations on data of a test case data entity. As aforementioned, database 106 may comprise one or more user libraries and one or more shared libraries, each storing different test case documentation data 350. The web server computing entity 104 may be in communication with an authentication system of the web server computing entity 104 to determine and/or verify an identity of a user profile of a client computing entity 102, so as to determine which user library of database 106 should be accessed.

The documentation engine 310 may comprise one or more functions and one or more submodules. In the example embodiment illustrated in FIG. 3, documentation engine 310 may comprise a screen capture submodule 311, a point-and-click submodule 312, a cloning submodule 313, a publishing submodule 314, a watcher management submodule 315, a custom fields submodule 316, a traceability submodule 317, a dynamic tagging submodule 318, and a version control submodule 319.

In some embodiments, the documentation engine 310 is configured to (i) generate and maintain test case documentation data 350 for a group of test case data entities, and (ii) store the test case documentation data 350 in the database 106. The documentation engine 310 may include at least one of: (i) a screen capture submodule 311 that is configured to generate session data entities, and generate and/or modify test case data entities based at least in part on the noted session data entities; (ii) a point-and-click submodule 312 that is configured to generate and/or modify test case data entities based at least in part on user-provided annotations defined in relation to input images; (iii) a cloning submodule 313 that is configured to enable cloning a parent test case data entity from a parent test case library to a local test case library; (iv) a publishing submodule 314 that is configured to enable publishing a local test case data entity from a local test case library to a parent test case library; (v) a watcher management submodule 315 that is configured to manage which user profiles are configured to receive updates about latest modifications to a test case data entity; (vi) a custom fields submodule 316 that is configured to enable defining features for a test case data entity including features having a custom (i.e., a user-defined) type; (vii) a traceability submodule 317 that is configured to generate traceability (e.g., cloning history, and/or the like) data for a test case data entity, including data associating a test case data entity to a requirements documents, a design document, defects, and/or any other associated documents or images; (viii) a dynamic tagging submodule 318 that is configured to generate dynamic tags for a test case data entity (e.g., including tags for all of a test case data entity and/or tags for individual interactive page elements that are associated with user actions corresponding to a test case data entity), and (ix) a version control submodule 319 that is configured to generate/maintain/update version control data for a test case data entity.

In some embodiments, the user interface generation engine 330 is configured to (i) receive end user queries in relation to test case documentation data 350, (ii) provide the end user queries to the inquiry engine 320, (iii) receive test case visualization data from the inquiry engine 320 in response to the end user queries, (iv) generate user interface data based at least in part on the test case visualization data, and (v) provide the user interface data to a client computing entity 102. As described above, examples of query types presented to the inquiry engine 320 include (i) requests for accessing/modifying a test case data entity, (ii) requests for accessing/modifying a test case page image, (iii) requests for accessing/modifying a test case step, (iv) requests for accessing/modifying test case traceability data, (v) requests for accessing/modifying test case watcher management data, (vi) accessing/modifying test case custom field data, (vii) accessing/modifying test case dynamic tagging data, (viii) requests for cloning a parent test case data entity from a parent test case library to a local test case library, and (ix) requests for publishing a local test case data entity from a local test case library to a particular parent test case library.

In some embodiments, the watcher management submodule 315 may be configured to assign watchers to a test case data entity, such that modifications to the test case data entity, executions of the test case data entity, and/or the like may result in a notification (e.g., via e-mail, text, and/or the like) to a specified recipient. The watcher management submodule 315 may in some embodiments be configured to allow only certain qualified end users and/or certain client computing entities 102 to manage watchers assigned to a test case data entity. In some embodiments, the custom fields submodule 316 may be configured to enable generating custom features for a test case data entity.

In some embodiments, the traceability submodule 317 may be configured to maintain traceability records within a test case data entity and update version numbers of a test case data entity. For example, a test case data entity that was previously published, cloned, and/or copied may contain traceability records (e.g., created by traceability submodule 317) stating such operations with additional metadata. For example, a test case data entity that has undergone significant modifications may have its version number incremented, such as by the traceability submodule 317. In some embodiments, the traceability submodule 317 may be configured to allow certain end users and/or certain client computing entities 102 (e.g., verified via authentication system) to view, edit, remove, and/or perform other such operations on traceability records.

In some embodiments, the dynamic tagging submodule 318 may be configured to assign and maintain classification tags associated with a test case data entity. For example, the dynamic tagging submodule 318 may display a plurality of classification tags associated with a test case data entity to certain end users and/or certain client computing entities 102 and further allow the association and disassociation of classification tags. In some embodiments, the set of tags that can be assigned to a test case data entity include at least one of the following: (i) a set of globally accessible tags that are available for all test case data entities managed by the test case manager module 108, (ii) a set of tags that are accessible for all test case data entities having the same tenant identifier as the test case data entity, and (iii) a set of tags that are accessible for all test case data entities having the same project identifier as the test case data entity.

In some embodiments, the version control submodule 319 is configured to generate version control data for a test case data entity. The version control data may be generated in a manner that enables multiple users to modify the same test cases at the same time and also provides recovery upon connection failures when a client computing entity 102 seeks to connect to the web server computing entity 104

Test case documentation data stored in the database 106 may contain metadata and/or content data associated with the test case data entities managed by test case manager module 108. Metadata for a the test case data entity may comprise watchers, custom fields, traceability records, version numbers, classification tags, and/or the like, which may be maintained by submodules of the documentation engine 310. Metadata for a test case data entity may further comprise test case identifiers (e.g., a local identifier, a global identifier, a UIUD) and/or the like, which may be used as search criteria by the inquiry engine 320. A test case data entity may be associated with content data such as test case steps, action features, action values, captured page images, captured user interactions, other nested test case data entities, and/or the like, which may be generated, edited, and/or shared via functions of the documentation engine 310. In some embodiments, web server computing entity 104 may be configured to generate a new test case data entity.

### Exemplary System Operations

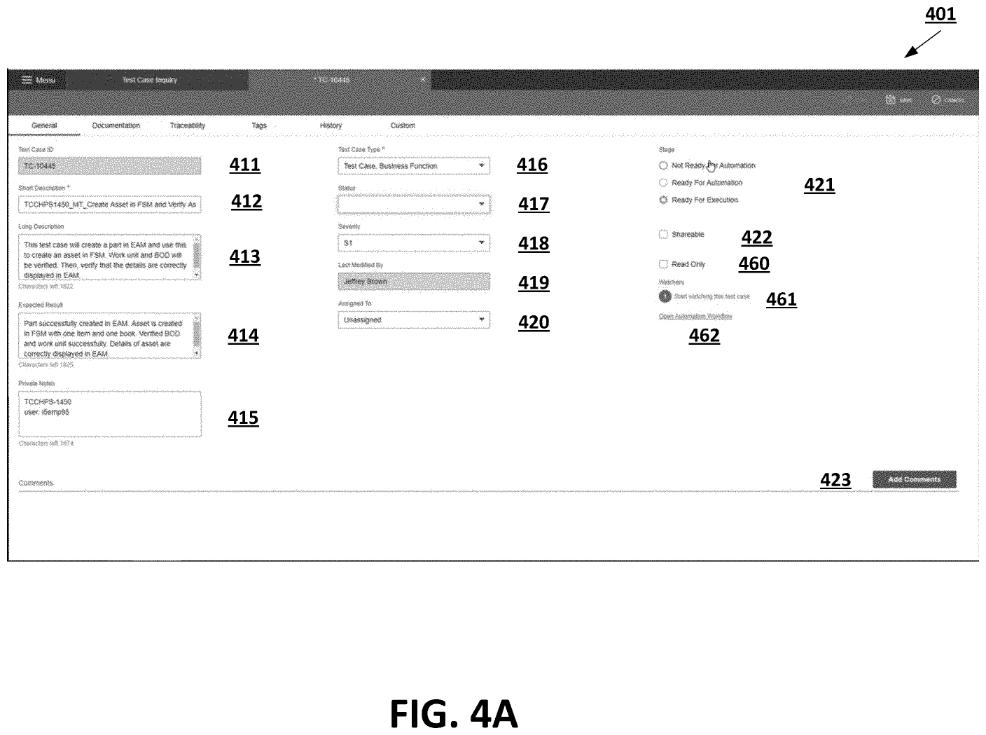

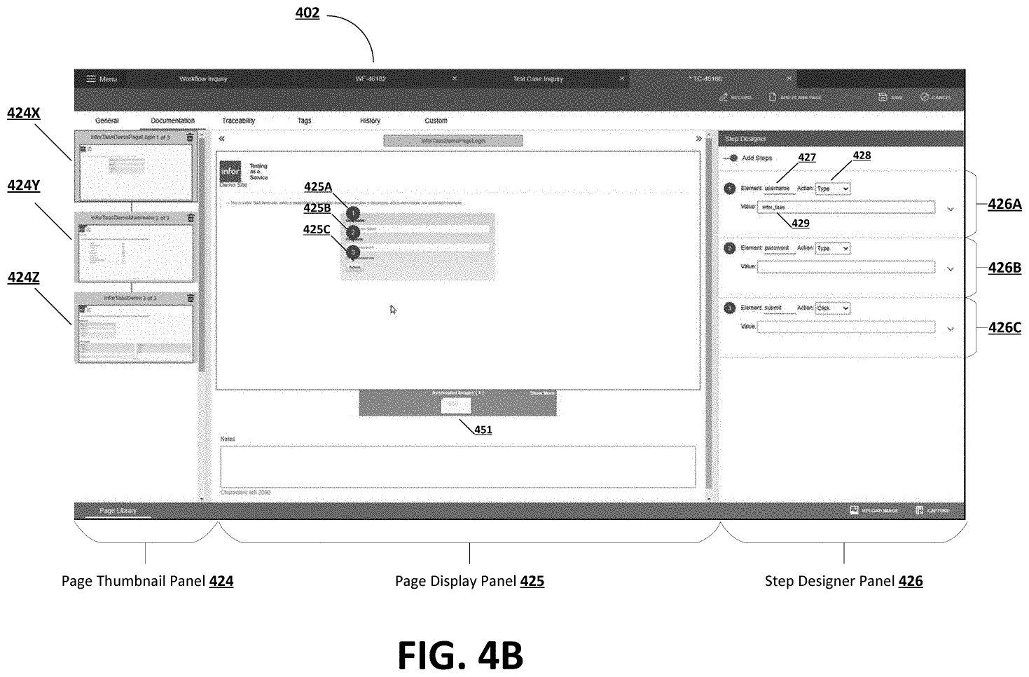

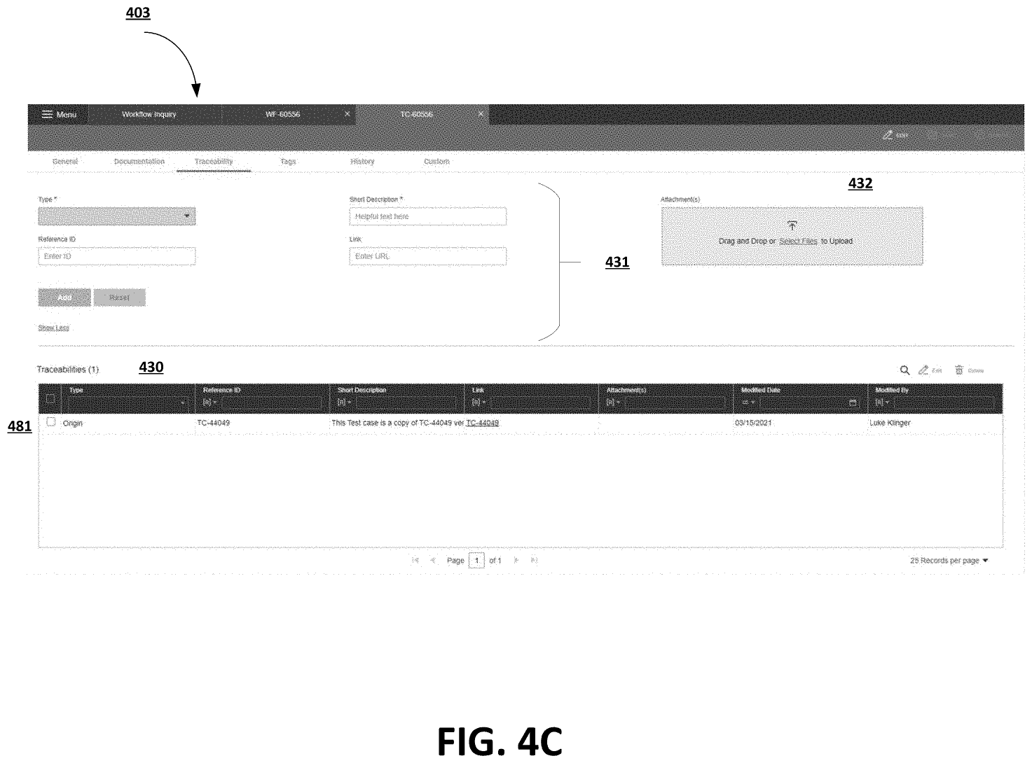

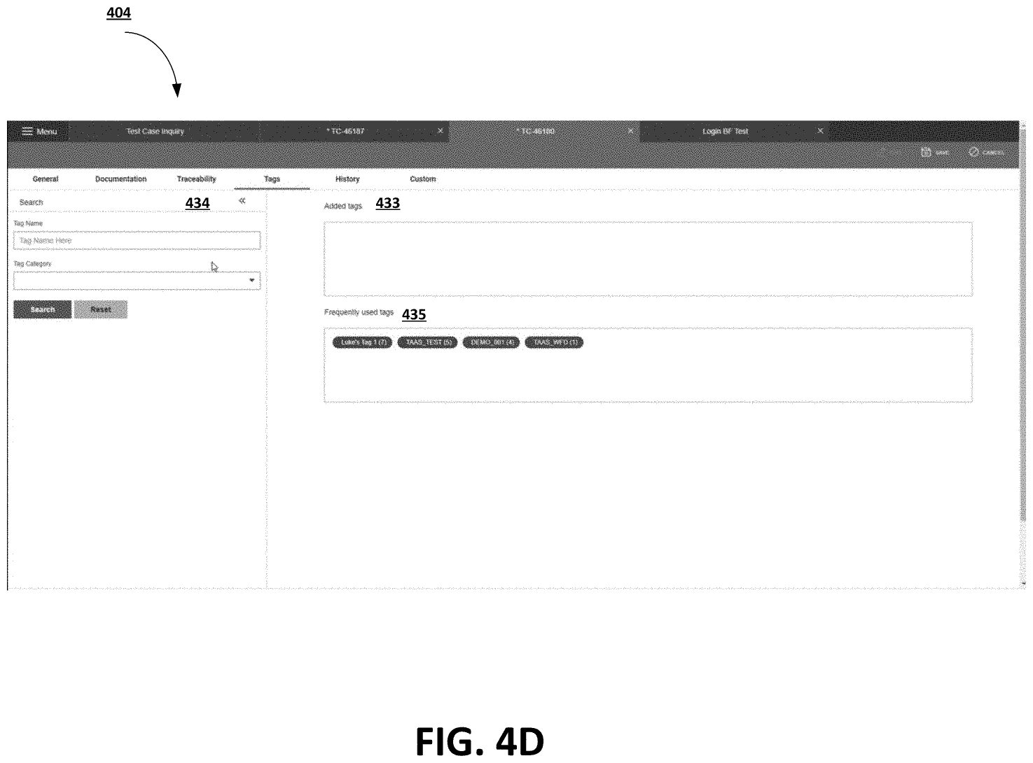

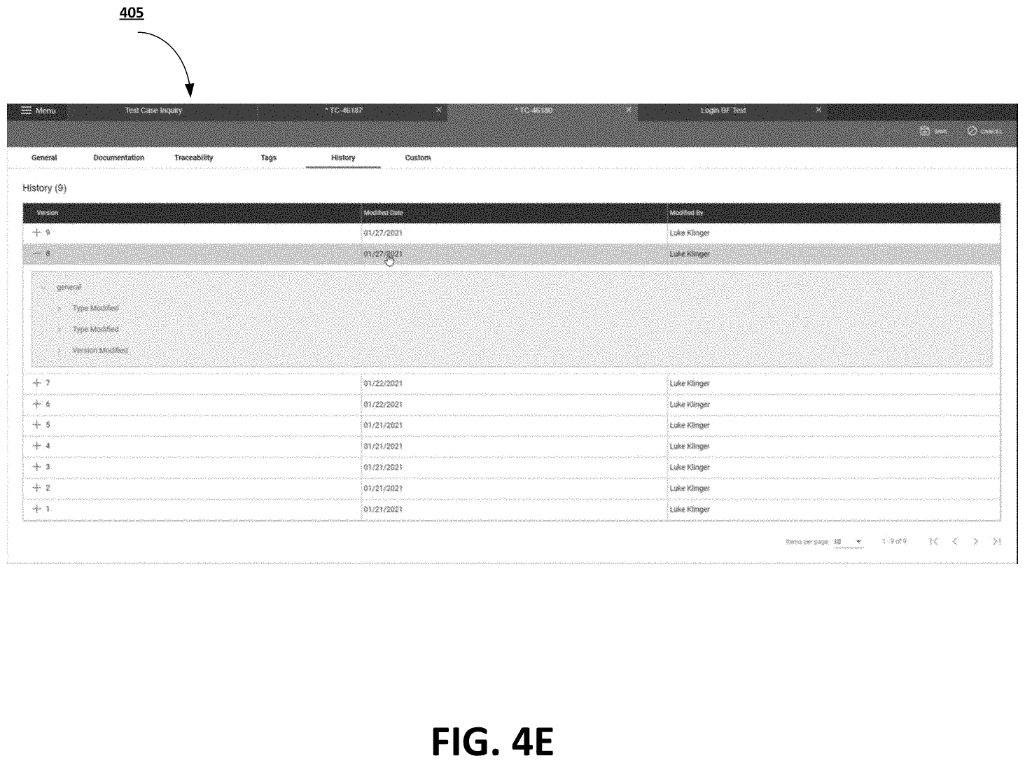

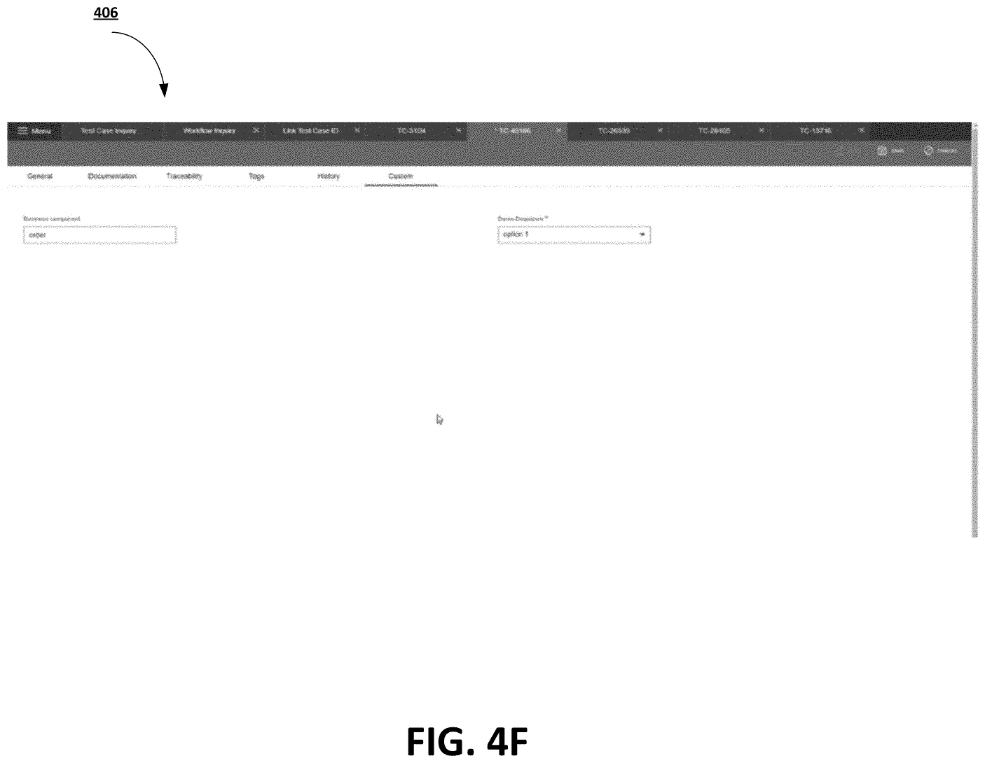

Various embodiments of the present invention describe innovative and technologically advantageous techniques for managing test case data entities, including for generating test case data entities, for modifying test case data entities, integrating test case data entities from source test case data entities into local test case libraries, for migrating test case data entities between one or more software platforms (e.g., between different instances of the same test automation platforms, across two or more different test automation platforms, and/or the like). Before proceeding to describe the noted techniques, however, we have provided descriptions of exemplary features of various components test case data entities, including test case page images and test case steps, as well as how those components can be used to generate test case visualization user interfaces, such as test case visualization user interface 401 of FIG. 4.

In general, a test case data entity may describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, and/or the like) associated with a corresponding test case. In some embodiments, a test case data entity is configured to describe: (i) one or more test case page images associated with the test case, and (ii) for each test case page image of the one or more test case page images, a set of test case steps that relate to the test case page image. In some embodiments, the test case data entity contains data that can be used to generate a test case visualization user interface for the test case associated with the test case data entity, such as a test case visualization user interface that depicts: (i) one or more test case page images associated with the test case, and (ii) for each test case page image of the one or more test case page images, a set of test case visualizations corresponding to each test case step in the set of test case steps that relate to the particular test case page image.

A test case page image may be an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

A test case step may describe a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example is placed at the upper left of the interactive page element), and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action, (ii) a user input value of the user action that may describe a value provided by the user to an interactive page element, (iii) a user action sequence identifier of the user action that may describe a temporal order of the user action within a set of sequential user actions performed with respect to interactive page elements of a webpage associated with the user action, and (iv) a user action time of the user action that may describe a captured time of the corresponding user action, and/or the like.

As described above, a test case data entity may be used to generate a test case visualization user interface, such as the test case visualization user interfaces 401-406 of FIGS. 4A-4F. As depicted in FIG. 4A, the test case visualization user interface 401 (corresponding to the “General” navigation tab of the depicted environment) describes general information about the test case associated with the test case data entity, including a test case identifier 411 for the test case, a short description 412 of the test case, a long description 413 of the test case, a description of the expected result 414 for the test case, private notes 415 for the test case, a test case type 416 of the test case (e.g., which may describe whether the test case is one or more of regular test case or a nestable test case, also referred to herein as a business function), a test case status 417 of the test case (e.g., a user-defined test case status, a system-defined test case status such as the user-defined test case status of “cloned” for a cloned test case data entity, and/or the like), a test case severity level 418 for the test case (e.g., a user-defined test case severity level 418), a last modifying user profile 419 for the test case, an assigned user profile 420 for the test case, a system-defined test case stage 421 for the test case, a shareable status 422 for the test case (which may be configured to enable or disable sharing the test case data entity to a source test case library from which test cases can be cloned/integrated), a read-only status 460 associated with the test case, any watcher user profiles 461 associated with the test case, and any comments 423 associated with the test case. The test case visualization user interface 401 also includes the button 462 that is configured to generate an automated workflow for the test case data entity.

As depicted in FIG. 4B, the test case visualization user interface 402 (corresponding to the “Documentation” navigation tab of the depicted environment) depicts test case page images and test case steps associated with a corresponding test case. In particular, a page thumbnail panel 424 of the test case visualization user interface 402 is configured to depict, for each webpage associated with the test case, a thumbnail image representation of an exemplary test case page image associated with the webpage. For example, the thumbnail image representation 424X corresponds to an exemplary test case page image for a first webpage associated with the test case, the thumbnail image representation 424Y corresponds to an exemplary test case page image for a second webpage associated with the test case, and the thumbnail image representation 424Z corresponds to an exemplary test case page image for a third webpage associated with the test case. The page thumbnail panel 424 may thus be used to selected one of the webpages associated with the test case. In some embodiments, the page thumbnail panel 424 enables re-sorting (i.e., changing the order of) webpages associated with the thumbnails, adding new webpages to the set of webpages associated with the thumbnails, and removing webpages from the set of webpages associated with the thumbnails.

Furthermore, as further depicted in FIG. 4B, a page display panel 425 of the test case visualization user interface 402 is configured to depict, for a selected webpage whose thumbnail image representation is selected using the page thumbnail panel 424, a selected test case page image that is selected/pre-selected using the image selection element 451. For example, because the selected webpage depicted in FIG. 4B is associated with only one test case page image, the noted test case page image is pre-selected and displayed using the page display panel 425.

As further depicted in FIG. 4B, the page display panel 425 is overlaid with three visual element identifiers each associated with a test case step corresponding to the selected test case page image. In particular, the three visual element identifiers overlaid on the selected test case page image depicted in FIG. 4B include the following visual element identifiers: (i) the visual element identifier 425A corresponding to the first textbox interactive page element of the selected webpage and thus a first test case step associated with the selected webpage, (ii) the visual element identifier 425B corresponding to the second textbox interactive page element of the selected webpage and thus a second test case step associated with the selected webpage, and (iii) the visual element identifier 425C corresponding to the third textbox interactive page element of the selected webpage and thus a third test case step associated with the selected webpage.

As further depicted in FIG. 4B, each visual element identifier of a test case step depicts a numerical value of the user action sequence identifier for the test case step that corresponds to the visual element identifier, where the user action sequence identifier may in turn describe when the user action corresponding to the test case step should be performed within a sequence of user actions corresponding to the test case steps of the selected webpage. For example, as depicted in FIG. 4B, the visual element identifier 425A corresponding to the first test case step depicts the numerical value of one, the visual element identifier 425B corresponding to the second test case step depicts the numerical value of two, and the visual element identifier 425C corresponding to the first test case step depicts the numerical value of three, a numbering that means that the first test case step is to be performed prior to the second test case step and the third test case step, and that the second test case step is configured to be performed prior to the third test case step.

As further depicted in FIG. 4B, a step designer panel 426 of the test case visualization user interface 402 is configured to depict, for each test case step associated with the selected webpage whose thumbnail image representation is selected using the page thumbnail panel 424, a test case step action feature element that is configured to describe action features associated with a user action corresponding to the test case step. For example, as depicted in FIG. 4B, the step designer panel 426 is configured to depict the following: (i) for the first test case step associated with the selected webpage, the first test case step action feature element 426A that describes action features of the user action associated with the first test case step, (ii) for the second test case step associated with the selected webpage, the second test case step action feature element 426B that describes action features of the user action associated with the second test case step, and (iii) for the third test case step associated with the selected webpage, the third test case step action feature element 426C that describes action features of the user action associated with the third test case step.

As further depicted in FIG. 4B, each test case step action feature element describes action features of the corresponding user action associated with the corresponding test case step, including an element label of the interactive page element associated with the corresponding user action, the user action type associated with the corresponding user action, and any user input values provided as part of the corresponding user action. For example, the first test case step action feature element 426A describes the following action features associated with the first test case step: the element label 427 (element label of “username”), the user action type 428 (the user action type of typing), and the user input value 429 (the user input value of “infor_taas”). In some embodiments, the element label is a user-provided label that is displayed to the end user, while the backend components continue to use element labels provided by the web developer in the XML of the HTML DOM. Thus, in some embodiments, data mapping user-provided element labels and developer-provided element labels is maintained by the web server computing entity 104.

As depicted in FIG. 4C, the test case visualization user interface 403 (corresponding to the “Traceability” navigation tab of the depicted environment) describes, as part of the traceability record 430, any source test case data entities (e.g., the source test case data entity 481) that have been cloned to generate the test case data entity associated with the test case visualization user interface 403. The test case visualization user interface 403 also enables, using the traceability field generation panel 431 and/or the traceability file upload panel 432, new fields describing new parent test case data entities (e.g., via explicit field generation and/or via uploading files describing the parent test case data entities) associated with new test case data entities to the traceability record 430.

As depicted in FIG. 4D, the test case visualization user interface 404 (corresponding to the “Tags” navigation tab of the depicted environment) describes one or more user-assigned tags for the corresponding test case using the tag display panel 433. The test case visualization user interface 404 further enables adding new tags to the test case using one or more of the following: (i) finding a tag using the tag search panel 434 and selecting the tag to add it to the user-assigned tags for the test case, and (ii) selecting a tag from the frequent tag panel 435 by selecting the particular tag. In some embodiments, the user may use the tag search panel 434 to search by keywords within the tag names and/or the category/color of the tag. In some embodiments, when a keyword is searched, the frequent tag panel 435 is converted into a result panel which will display search result in a relevancy order, with the tags that most closely match the search criteria, by relevancy, being be displayed first. In some embodiments, a tag that is displayed using the frequent tag panel or the results panel has a parenthetical numeric designator associated with it, where the parenthetical numeric designator describes the count of usage of the tag within a set of test case data entities that are in a search scope of the primary test case data entity.

In some embodiments, clicking on a tag in the tag display panel 433 will remove the tag from the tag display panel 433 and return the tag to the frequent tag panel 435. In some embodiments, if the user selects a first tag having a first color designation, then searches for tags having a second color designation, and subsequently removes the first tag from the display panel 433, the first tag is added to the search result panel despite having an inconsistent color designation, in order to enable convenient addition of the removed tag to the display panel 433 in the event of erroneous/unintended removal of the noted tag.

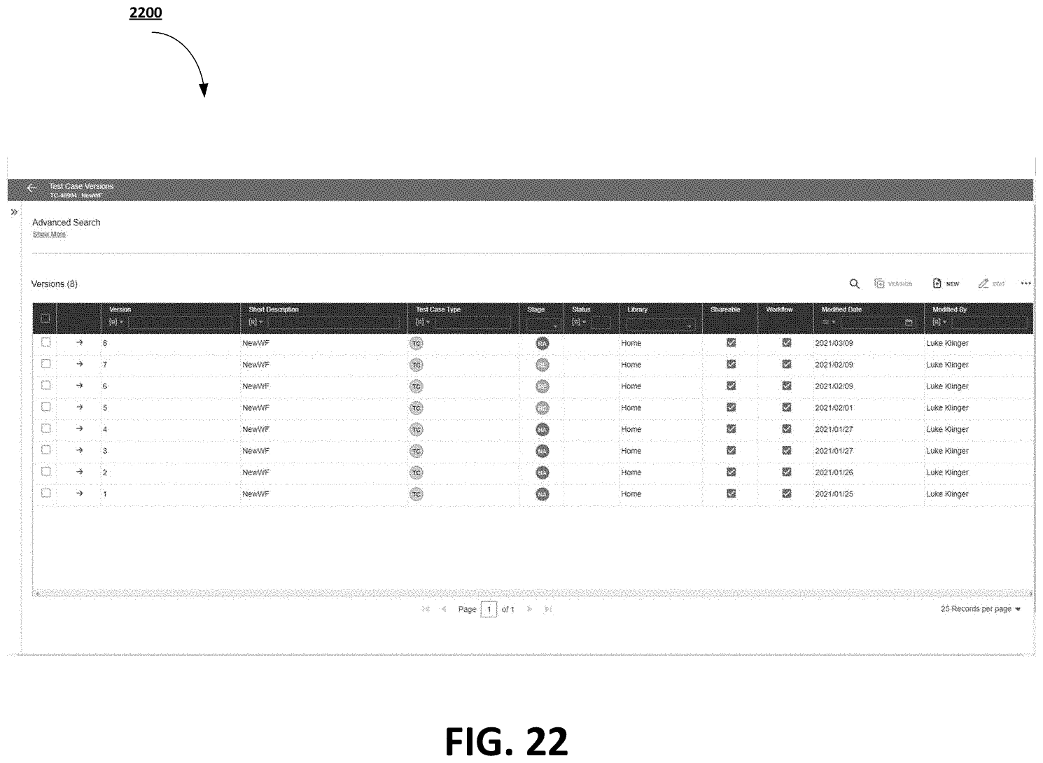

As depicted in FIG. 4E, the test case visualization user interface 405 (corresponding to the “History” navigation tab of the depicted environment) enables viewing the revision history of the corresponding test case. For each selected revision history version of the test case, the test case visualization user interface 405 describes the changes made by the revision history version to a previous revision history version, the revision date of the noted changes, and the user profile associated with the noted changes. For example, as depicted in the test case visualization user interface 405, the eighth revision history of the test case is associated with modifying the test case type 416 of the test case twice and modifying the version of the test case. In some embodiments, version history of a test case data entity can be modified using a test case version control user interface, such as the test case version control user interface 2200 of FIG. 22.

As depicted in FIG. 4F, the test case visualization user interface 406 (corresponding to the “Custom” navigation tab of the depicted environment) describes one or more user-defined feature values for the test case, where the feature types of the user-defined feature values may be defined by the test case developer of the corresponding test case. Therefore, the test case visualization user interface 406 depicts feature values custom (i.e., user-defined) feature values for the test case. For example, the test case visualization user interface 406 of FIG. 4F is associated with the business component custom feature and the demo dropdown custom feature.

### Captured Test Case Data Entities

In some embodiments, a test case data entity may be generated and/or modified using screen capture techniques described below. In some embodiments, once created using screen capture techniques described below, a created test case data entity may be modified using any of the techniques described herein for modifying test case data entities. While various embodiments of the present invention describe techniques for generating test case data entities using screen capture technologies described below, a person of ordinary skill in the relevant technology will recognize that the disclosed techniques can be used to modify an existing test case data entity by generating new test case page images and/or new test case steps for the existing test case data entity.

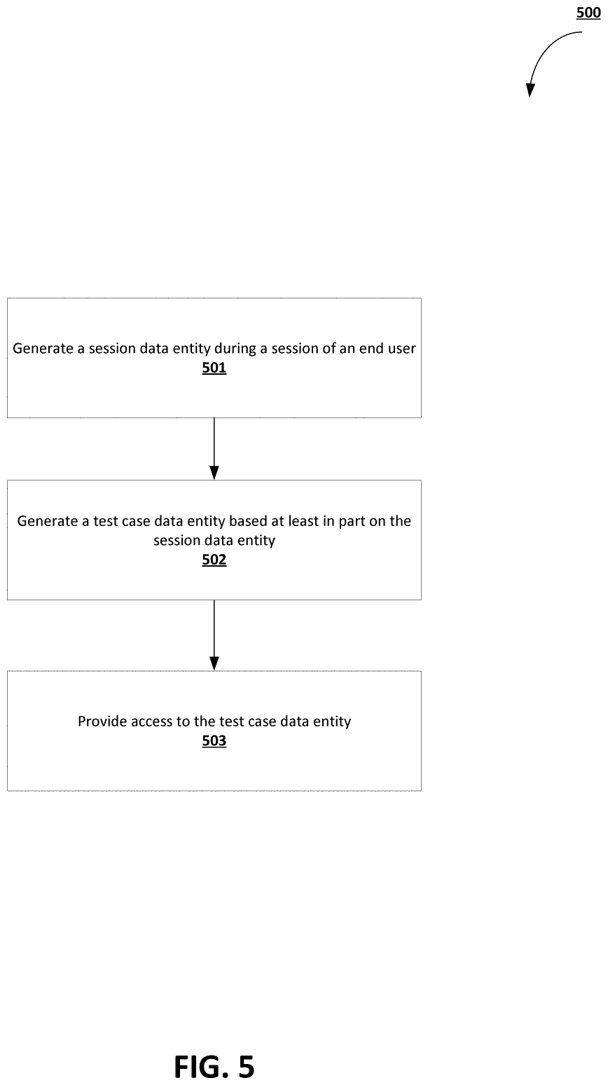

FIG. 5 is a flowchart diagram of an example process 500 for generating a test case data entity based at least in part on a session data entity. Via the various steps/operations of the process 500, the web server computing entity 104 can enable efficient and reliable generation of test case data entities using session data entities that capture user interactions with an ordered sequence of captured page images.

The process 500 begins at step/operation 501 when the web server computing entity 104 generates a session data entity during a session of an end user. In some embodiments, the web server computing entity 104 utilizes one or more web browser extensions to capture user interactions with an ordered sequence of webpages and uses captured images corresponding to the ordered sequence and the captured user interactions to generate the session data entity.

In some embodiments, the session data entity may describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and selects a second designated button on the second webpage. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured, and (ii) for each webpage of the sequence of webpages, a set of user interactions performed in relation to the noted webpage. For example, for the exemplary session data entity described above, the session data entity may describe: (i) a sequence of webpages that describes that the first webpage was visited first and the second webpage was subsequently visited, (ii) for the first webpage, the user interactions corresponding to entering a text input in the first designated textbox on the first webpage, selecting the first designated checkbox on the first webpage, and selecting the first designated button on the first webpage, and (iii) for the second webpage, the user interactions corresponding to selecting the first designated radio button from the first designated set of related radio buttons on the second webpage and selecting the second designated button on the second webpage. In some embodiments, the session data entity comprises (a) an ordered sequence of a plurality of captured page images that (i) were captured during the session, and (ii) correspond to a plurality of webpages visited by the end user during the session, and (b) a plurality of captured user interactions performed by the end user while interacting with the plurality of webpages.

A captured page image, which is an example of a test case page image, may describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are performed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are performed.

While various embodiments of the present invention describe session data entities in which a visited webpage is associated with a single captured page image, a person of ordinary skill in the relevant technology will recognize that in some embodiments a visited webpage may be associated with two or more captured page images. In some embodiments, a software component (e.g., a web browser extension) that is configured to generate a session data entities may detect presence of particular expandable interactive page elements within a visited webpage elements within a visited webpage and, upon detection of user interactions configured to expand an expandable interactive page element, generate a captured page image based at least in part on a screenshot of the visited webpage during a visual state in which the expandable interactive page element is in an expanded state. For example, consider a webpage that includes a dropdown menu interactive page element. In the noted example, some captured page images associated with the webpage may depict a visual state of the webpage in which the dropdown menu interactive page element is in a non-expanded state. In some embodiments, upon detection of a user interaction that is configured to expand the dropdown menu interactive page element, a software component (e.g., a web browser extension) that is configured to generate session data entities may generate a screenshot of a visual state of the webpage in which the dropdown menu interactive page element is in a non-expanded state, and use the generated screenshot to generate an alternative captured page image for the particular webpage. In some embodiments, a software component (e.g., a web browser extension) that is configured to generate a session data entities may detect transitory display of particular transitory outputs (e.g., notifications) in relation to a visited webpage. In some of the noted embodiments, the noted software component may generate a screenshot of the visited webpage during a transitory display of a particular transitory output (e.g., a particular notification) and use the generated screenshot to generate an alternative captured page image for the particular visited webpage.

A captured user interaction may describe a recorded/captured user action with respect to a segment of a webpage, where the captured user interaction may be described by a session data entity corresponding to a recorded/captured session that included performing the corresponding user action associated with the captured user interaction. In some embodiments, a captured user interaction describes: (i) an associated interactive page element within a corresponding webpage with respect to which the corresponding user action was performed during the recorded/captured session, (ii) a user action type of the corresponding user action with respect to the associated interactive page element within the corresponding webpage, and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction, and (ii) (i.e., clicking) as the user action type of the captured user interaction. As another example, consider a recorded/captured session that included the user action of typing “pshoghi” into a username textbox. In the noted example, the captured user interaction corresponding to the noted user action may describe: (i) the username textbox as the interactive page element corresponding to the captured user interaction, (ii) typing (i.e., inputting text) as the user action type corresponding to the captured user interaction, and (iii) because the user action type of typing requires a user input value, the text input value “pshoghi” as the user input value for the captured user interaction. Other examples of qualified user actions that can be associated with captured user interactions include: drag and drop actions, opening/closing tabs within a browser, file upload/download, browser actions (e.g., refreshing, clicking on a “back” button to get a previously-visited page), navigating to a new webpage, hotkey events (e.g., pressing at least one ctrl+a, ctrl+c, ctrl+z, etc.), and/or the like. In some embodiments, opening a tab can be performed in multiple ways. During a sequence of events within a session, the user may click to manually navigate to another web site via another browser tab, or the application itself may launch another web site via another browser tab.

In some embodiments, a captured user interaction is associated with (i) a captured page image, (ii) an interactive page element, and (ii) a set of action features. The captured page image for a captured user interaction may describe an image of a corresponding webpage with respect to which a user action corresponding to the captured user interaction is performed, while an interactive page element may describe an element (e.g., an interactive page element, an HTML element, and/or the like) of the corresponding webpage, where the user action corresponding to the captured user interaction is performed exclusively by changing a state and/or a value of the particular element. An action feature of a captured user interaction may describe any property of a user action intended to change a state and/or a value of an interactive page element, where the user action is recorded/captured using a captured user interaction in a session data entity. Examples of action features for a captured user interaction include (i) a user action type of a user action associated with the captured user interaction that may describe a general mode of user interaction with an interactive page element which may be defined based at least in part on an interactive page element type of the interactive page element, (ii) a user input value of a user action associated with the captured user interaction that may describe a finalized (rather than intermediate) value of a user action with respect to an interactive page element, (iii) a user action sequence identifier of a user action associated with the captured user interaction that may describe a temporal order of the user action within a set of sequential user actions performed with respect to interactive page elements of a webpage associated with the user action, (iv) a user action time of a user action associated with the captured user interaction that may describe a captured time of the corresponding user action, and/or the like.

As described above, the user input value of a captured user interaction may describe a finalized rather than an intermediate value of a user action associated with the user input value. This means that if, during the course of a session, an end user performs multiple conflicting actions with respect to an interactive page element, then only the final user action will be used to generate the user input value for a captured user inaction associated with the noted interactive page element. For example, consider a session during which an end user first selects a checkbox and then unselects the selected checkbox. In the noted example, a component (e.g., a web browser extension) that is configured to generate a session data entity for the session may not generate a captured user interaction for the noted conflicting actions with respect to the checkbox interactive page element. As another example, consider a session during which an end user first types “pshoghg” into a text box, then removes the final character of the noted text input and instead types an “i” character. In the noted example, a component (e.g., a web browser extension) that is configured to generate a session data entity for the session may generate a captured user interaction with respect to the text box that is associated with the user input value “pshoghi.” As yet another example, consider a session during which an end user first types “pshoghi” into a text box, then at a subsequent time prior to loading a subsequent webpage removes “pshoghi” from the text box and types “jbrown” instead. In the noted example, a component (e.g., a web browser extension) that is configured to generate a session data entity for the session may generate a captured user interaction with respect to the text box that is associated with the user input value “jbrown.” In some embodiments, the web server computing entity 104 is not a key logger and captures the totality of the final text entered by the user.

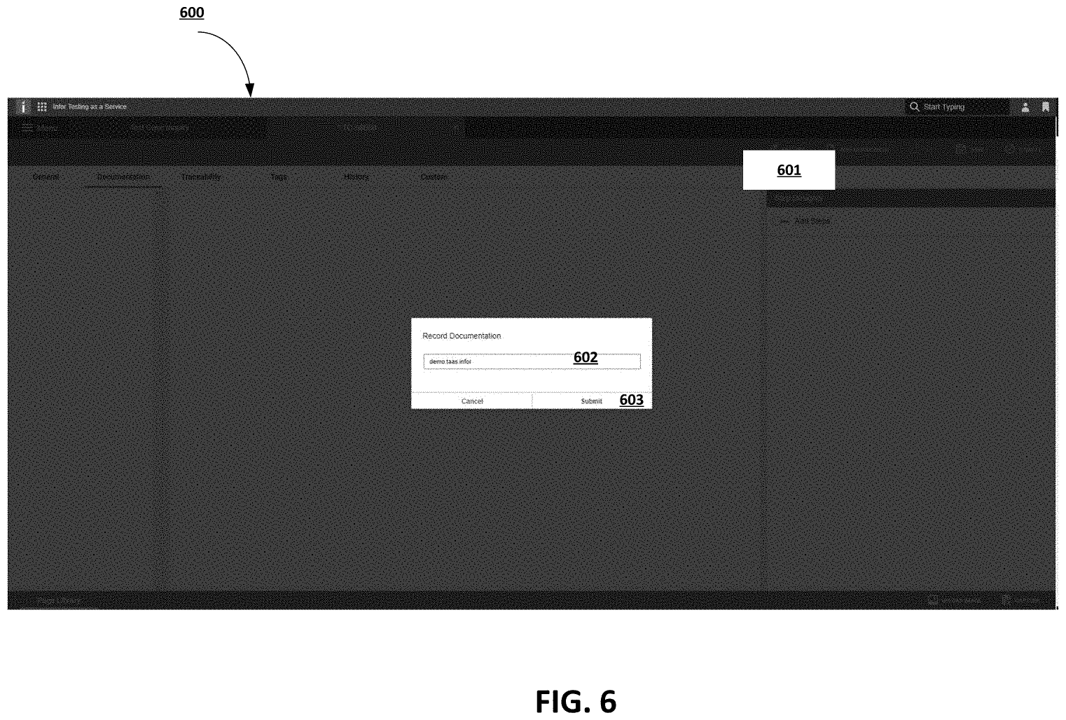

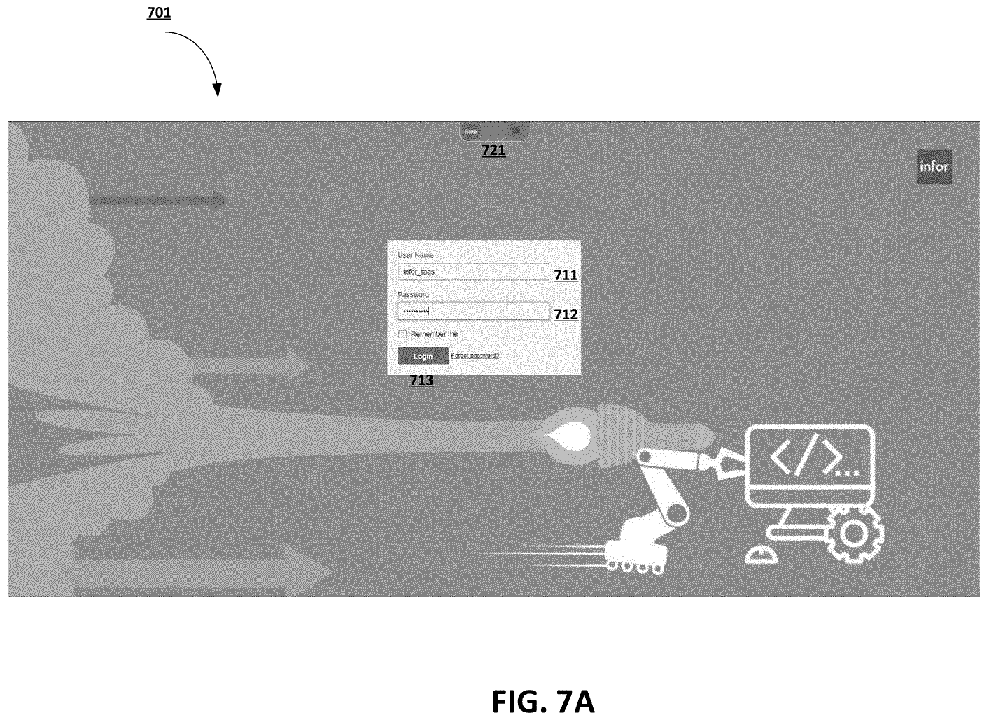

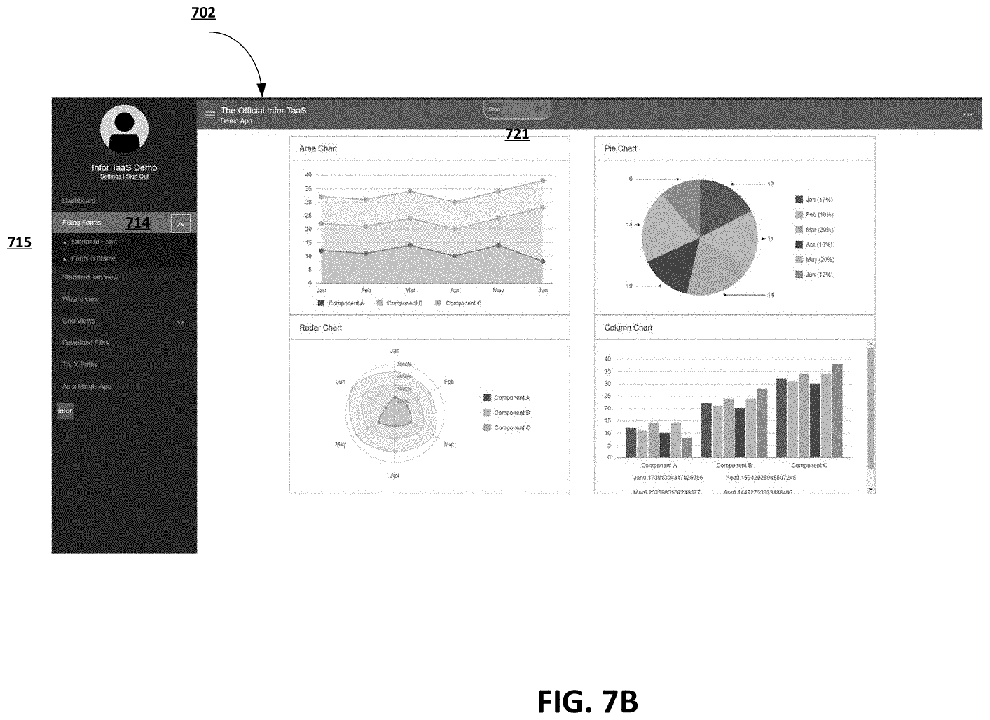

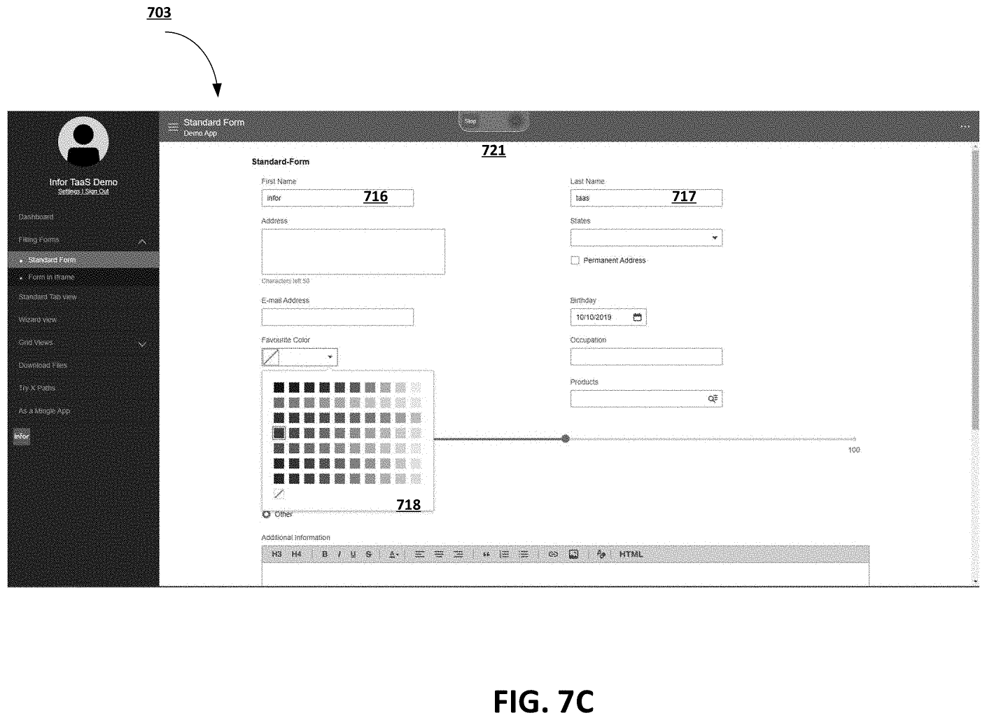

An operational example of user actions configured to generate a session data entity is depicted in FIG. 6 and FIGS. 7A-7C. As depicted in FIG. 6A, within the webpage 600, the user selects the record button 601, a user action that leads to display of the textbox 602 configured to receive a starting webpage of a session (which may by default be stored to a previously-stored webpage address). After the user enters the Uniform Resource Locator (URL) of the starting webpage within the textbox 602 and selects the submit button 603, the web server computing entity 104 generates the session by loading the webpage, which leads to generating the webpage 701 of FIG. 7A and beginning of the captured session. In the particular session depicted using the FIGS. 7A-7C, user selection of the button 713 causes transition to the webpage 702 of FIG. 7B. Within the webpage 703, user interaction with the button 714 causes transition to the webpage 703 of FIG. 7C. Moreover, within webpage 703, user interaction with the button 721 causes termination of the session without transitioning from the webpage 703. During the session, within the webpages 701-703 of FIGS. 7A-7C, the user first types text into the textbox 711, then types text into the textbox 712, then selects the button 713, then selects the button 714, then selects the button 715, then types text into textbox 716, then types text into textbox 717, and then selects a color from the dropdown menu 718. The button 721 can be used to start recording, pause a recorded session, and end a recorded session.

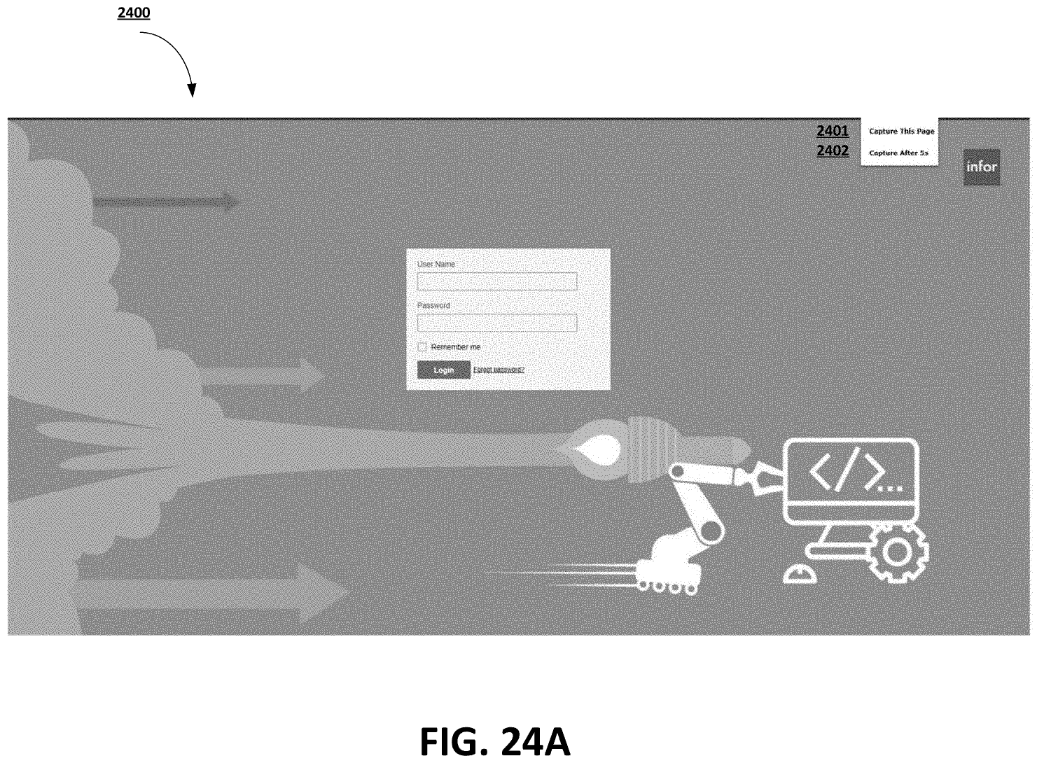

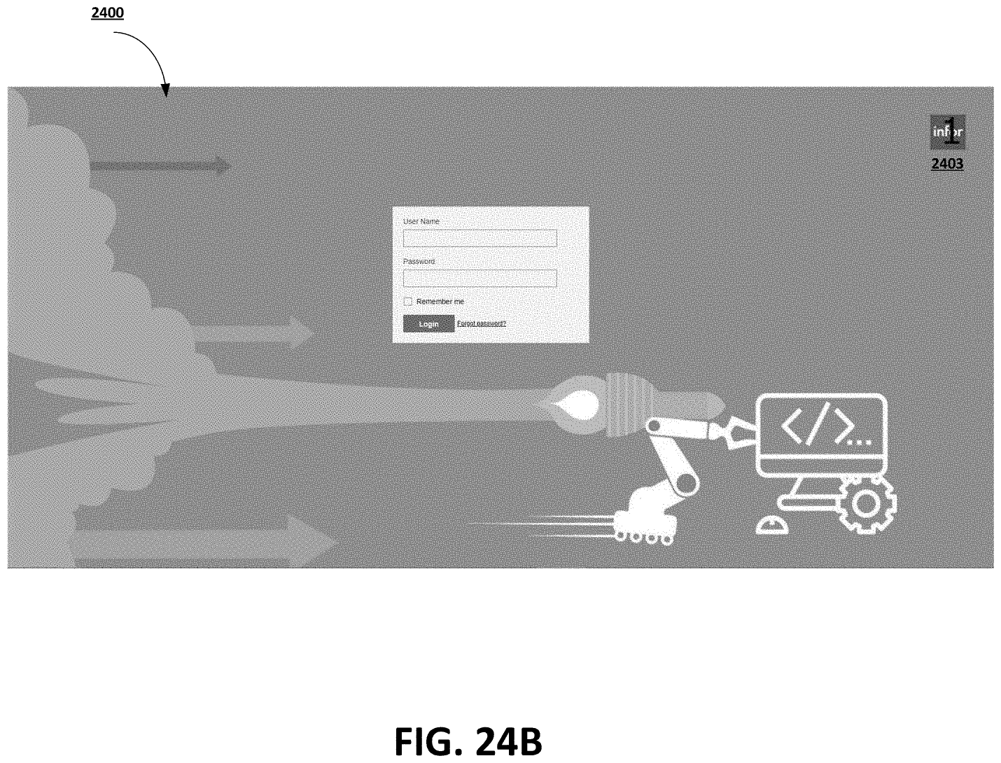

In some embodiments, the web server computing entity 104 can perform any of the following actions: (i) in a record mode, record a sequence of captured user actions and associated captured page images after the user selects to record, and (ii) in a capture mode, record captured page images and any element metadata for any interactive page elements within the webpage being captured after the user selects to capture. This facilitates capturing an image of a webpage where clicking the capture button itself may change the current state of the page. For example, if user clicks to open a dropdown and selects to capture the screen in this state, the nature of clicking the “capture” button would close the dropdown. Whereas, if the user clicks the “delayed capture” button, the user can then click to open the dropdown and have it in the “opened” state so the system will capture the page in the desired state at the end of the 5 second countdown. The capture mode may also enable the user to either capture a new image associated with an additional state of the webpage or replace an existing image with an updated image. This ‘replacement’ of a webpage is primarily used to facilitate when the application has changed something on the screen, thereby making the previous image obsolete, for example a new field being added or an old field being removed, or a button changed from “OK” to “Submit”. An operational example of a set of operations by the web server computing entity 104 in relation to the capture mode is depicted in FIGS. 24A-24B. As depicted in FIG. 24B, the web server computing entity 104 causes presentation of the webpage 2400 which enables an immediate capture mode 2401 and a delayed capture mode 2402. As depicted in FIG. 24B, the webpage 2400 displays a countdown 2403 in response to the selection of the delayed capture mode.

In some embodiments, the session data entity generated based at least in part on the session depicted in FIGS. 7A-7C may be associated with captured page images that correspond to webpages 701-703 as well as the following captured user interactions: (i) a first captured user interaction associated with typing “infor_taas” into the textbox 711, (ii) a second captured user interaction associated with typing a password into the textbox 712, (iii) a third captured user interaction associated with selecting the button 713, (iv) a fourth captured user interaction associated with selecting the button 714, (v) a fifth captured user interaction associated with selecting the button 715, (vi) a sixth captured user interaction associated with typing “infor” into the textbox 716, (vii) a seventh captured user interaction associated with typing “taas” into the textbox 717, and (viii) an eighth captured user interaction associated with selecting the dark green color within the dropdown menu 718.

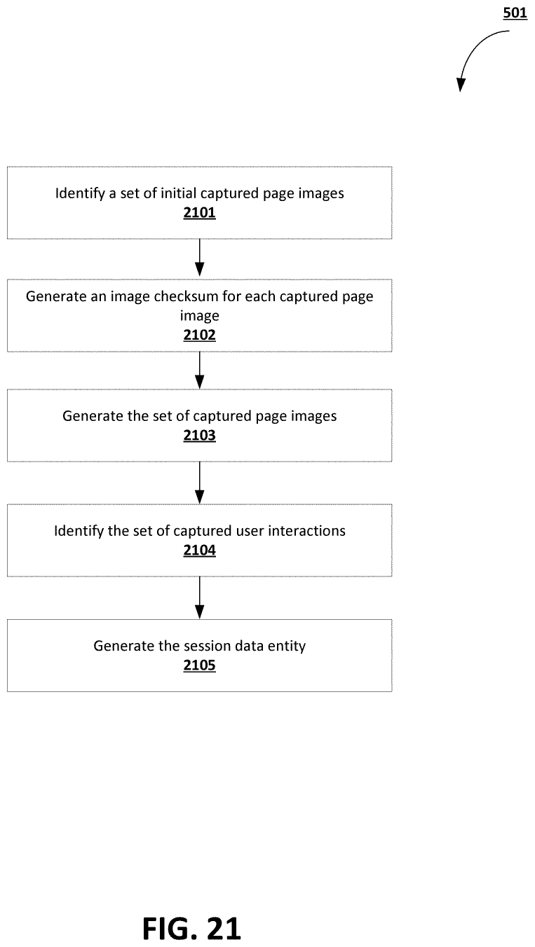

In some embodiments, step/operation 501 is performed in accordance with the process that is depicted in FIG. 21. The process that is depicted in FIG. 21 begins at step/operation 2101 when the web server computing entity 104 identifies a set of initial captured page images for a session of an end user. In some embodiments, a screen capture component (e.g., a web browser extension) that operates on a client computing entity 102 generates one or more screen capture data objects during the session and transmits the screen capture data objects to the web server computing entity 104. The screen capture data objects may be generated by the screen capture component when the end user is detected to have performed an interaction with a webpage during the session, where the initiation and the termination of the session may also be indicated by the end user (e.g., via interacting with buttons on a screen capture user interface displayed by the client computing entity 102).

A screen capture data object may be any data object that can be used to generate a captured page image. The screen capture data objects may comprise screenshots of a web browser interface using which the session is performed, where the screenshots can then be used by the web server computing entity 104 as the initial captured page images. The screen capture data objects may also include other data that can be used to generate initial captured page images by the web server computing entity 104, such as an HTML Document Object Model (DOM) file.

At step/operation 2102, the web server computing entity 104 determines, for each initial captured page image of the set of initial captured page images, an image checksum value. The image checksum value for a particular initial captured page image may be a value that may be used for verifying if another initial captured page image depicts the same webpage as the particular initial captured page image (e.g., a hashed representation of a webpage visual state described by the particular initial captured page image). In some embodiments, the screen capture component described above may generate the hashed representation and provide the hashed representation to the web server computing entity 104. In some embodiments, the web server computing entity 104 may determine the hashed representation based at least in part on a screen capture data object (e.g., an HTML DOM file) provided by the client computing entity 102 and/or based at least in part on an initial captured page image generated by the web server computing entity 104 based at least in part on a screen capture data object provided by the client computing entity 102. The image checksum value for an initial captured page image may describe a representation of the relative location of various interactive page element in the webpage corresponding to the initial captured page image and/or a representation of the states of various interactive page elements in the webpage, and may be determined based at least in part on the HTML data associated with the webpage.

At step/operation 2103, the web server computing entity 104 determines the set of captured page images based at least in part on each image checksum value for an initial captured page image. In some embodiments, to the extent the image checksum values for two or more initial captured page images describes that the two or more initial captured page images refer to the same webpage visual state, only one of the two or more initial captured page images is adopted among the set of captured page images. For example, if the set of initial captured page images for a session include C1-C3, where C1 and C2 have the same image checksum value, then the set of captured page images for the session may include C1 and C3.

At step/operation 2104, the web server computing entity 104 identifies the set of captured user interactions. In some embodiments, the screen capture component described above (which may, for example, be a JavaScript extension) attaches itself to listener methods of at least some of the page elements (e.g., a set of page elements that are deemed to be actionable page elements based at least in part on actionable page element detection rules associated with the screen capture component) in the HTML code of the webpages associated with the captured session, and then detecting the set of captured user interactions based at least in part on the data detected via listening to the listener methods. After detecting the captured user interactions, the screen capture component may transmit the noted captured user interactions to the web server computing entity 104. In some embodiments, the web server computing entity 104 identifies actionable page elements associated with a webpage based at least in part on a set of page elements that are associated with listener methods (e.g., JavaScript listener methods), as determined based on the HTML DOM for the webpage.

At step/operation 2105, the web server computing entity 104 generates the session data entity based at least in part on the set of captured page images and the set of captured user interactions. As described above, the session data entity may comprise: (a) an ordered sequence of a plurality of captured page images that (i) were captured during the session, and (ii) correspond to a plurality of webpages visited by the end user during the session, and (b) a plurality of captured user interactions performed by the end user while interacting with the plurality of webpages.

In some embodiments, subsequent to beginning of recording of a session, a screen capture component (e.g., a web browser extension) injects event listeners into a webpage. If the event listener detects performance of an action, the screen capture component determines whether the webpage has a custom title defined. If the webpage has a custom title defined, the custom page title is adopted as a page title for the page; otherwise, default page title generation logics are used to generate the page title. Subsequent to determining the page title, the screen capture component generates a page checksum for the page based on the page title, generates a screenshot of the page, generates an image checksum for the webpage based on the visible page elements in accordance with the screenshots, collects any required metadata about the webpage, and sends the screenshot, the checksums, and the collected metadata to the web server computing entity 104. The web server computing entity 104 may be configured to determine if the page checksum exists in a page library. If the page checksum exists, the web server computing entity 104 identifies the existing page for the webpage and iterates over the page elements of the existing page to determine whether each page element exists, add location data for non-existent page elements, and replace location data of existing page elements. If the page checksum does not exist, the web server computing entity 104 creates a new page and adds elements (along with location data of the page elements) for the newly-added page. The web server computing entity 104 may further be configured to determine whether the image checksum exists. If the image checksum exists, the web server computing entity 104: (i) iterates over screen elements (i.e., page elements depicted by the corresponding screenshot) by determining whether each screen element exists and inserting new screen elements with coordinates for non-existent elements, and (ii) replaces element coordinates for existing screen elements if a coordinate checksum of the existing screenshot and a coordinate checksum of a new screenshot do not match. If the image checksum does not exist, the web server computing entity 104 saves the new screenshots with all corresponding screen element coordinates.

At step/operation 502, the web server computing entity 104 generates a test case data entity based at least in part on the session data entity. In some embodiments, the web server computing entity 104 uses the captured page images of the session data entity to generate the test case page images of the test case data entity, and uses the captured user interactions of the session data entity to generate test case steps associated with the test case page images of the test case data entity. In some embodiments, the test case data entity comprises (i) a plurality of test case page images corresponding to the plurality of captured page images, and (ii) one or more test case steps associated with each of the plurality of test case page images.

A test case page image may describe a component of a test case data entity that depicts an image associated with a state of a webpage associated with a test case corresponding to the test case data entity. For example, in some embodiments, a test case page image may depict a webpage image that is determined based at least in part on a session data entity associated with the test case data entity. As another example, in some embodiments, a test case page image may depict a user-uploaded image that is configured to depict a state of a webpage associated with a corresponding test case data entity. As described above, in some embodiments, a webpage associated with a test case data entity may be associated with more than one test case page image, such as a first test case page image that depicts an expandable interactive page element associated with the webpage in an expanded state and a second test case page image that depicts an expandable interactive page element associated with the webpage in a non-expanded state.

A test case step may describe a user action required by a test case associated with a corresponding test case data entity, where the user action may be performed with respect to an interactive page element of a webpage associated with a test case page image of the corresponding test case data entity. In some embodiments, a test case step is associated with visual element identifier overlaid on the test case page image in an overlay location associated with a region of the test case page image that corresponds to the interactive page element for the test case step. For example, if a test case step corresponds to the user action of selecting a particular button on a particular webpage, an image region of a test case page image for the particular webpage that corresponds to a location of the particular button on the particular webpage may be overlaid with a visual element identifier for the user action corresponding to noted test case step. In addition, a user interface depicting a test case page image may include a test case step metadata user interface element that describes one or more action features of the user action that corresponds to the test case step. Examples of user actions that may be described by test case steps include captured user interactions as well as user actions defined by end users explicitly via creating visual element identifier and/or actions features for the noted user actions.

For example, the session data entity generated based at least in part on the session depicted in FIGS. 7A-7C may be used to generate a test case data entity that is in turn configured to describe: (i) a first test case page image corresponding to the webpage 701, a second test case page image corresponding to the webpage 702, and a third test case page image corresponding to the webpage 703; (ii) for the test first case page image, a first test case step for the first captured user interaction associated with typing “infor_taas” into the textbox 711, a second test case step for the second captured user interaction associated with typing a password into the textbox 712, and a third test case step for the third captured user interaction associated with selecting the button 713; (iii) for the second test case page image, a first test case step for the fourth captured user interaction associated with selecting the button 714 and the fifth captured user interaction associated with selecting the button 715; and (iv) for the third test case page image, a first test case step for the sixth captured user interaction associated with typing “infor” into the textbox 716, a second test case step for the seventh captured user interaction associated with typing “taas” into the textbox 717, and a third test case step for the eighth captured user interaction associated with selecting the dark green color within the dropdown menu 718.

At step/operation 503, the web server computing entity 104 provides the test case data entity using a test case visualization user interface. In some embodiments, the web server computing entity 104 generates a test case visualization user interface data object for the test case visualization user interface and provides the test case visualization user interface data object to a client computing entity 102, where the client computing entity 102 may be configured to present a test case visualization user interface to an end user based at least in part on the test case visualization user interface data object.

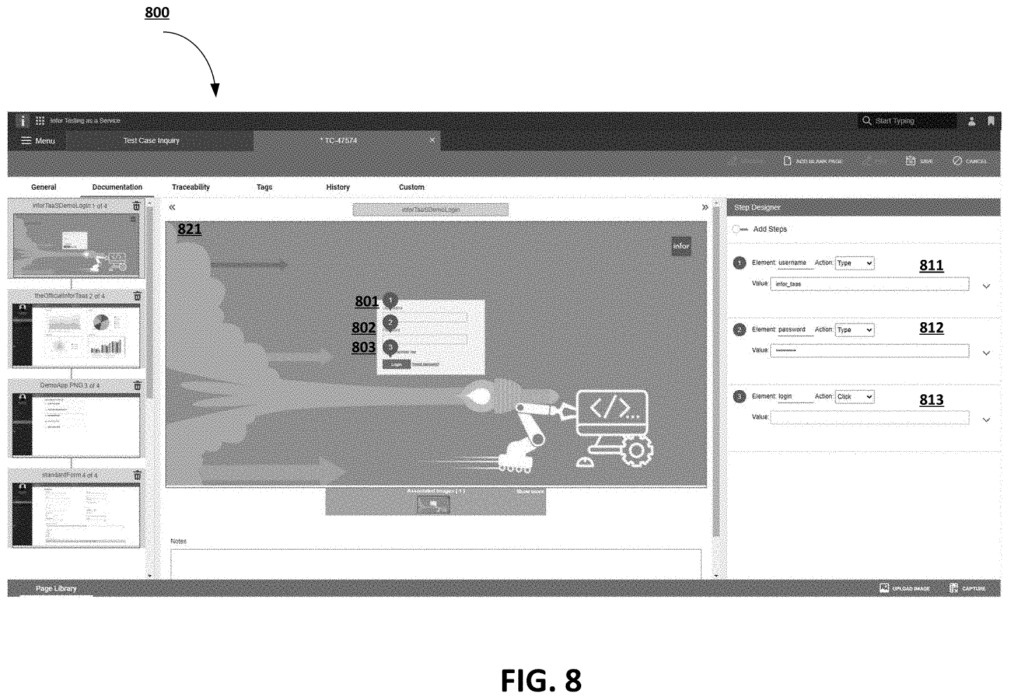

FIG. 8 depicts a test case visualization user interface 800 that is generated based at least in part on the session data entity for the session depicted in FIGS. 7A-7C. As depicted in FIG. 8, the test case visualization user interface 800 depicts: (i) at least one test case page image for each webpage of the session, including the test case page image 821 for the first webpage which is the selected webpage, (ii) the visual element identifier 801 and the test case step action feature element 811 for a first test case step, (iii) the visual element identifier 802 and the test case step action feature element 812 for a second test case step, and (iv) the visual element identifier 803 and the test case step action feature element 813 for a third test case step.

The above-described techniques for generating captured test case data entities are configured to provide test case generation techniques that are more user-friendly and intuitive. The user-friendly and intuitive test case generation techniques enhance the accuracy and reliability of test case data entities generated by test case developers (including the efficiency of generating the test cases), which in turn reduces the number of erroneous testing operations (e.g., erroneous automated testing operations) that are performed. Reducing the number of erroneous testing operations improves the operational efficiency of test automation platforms by reducing the number of processing operations that need to be performed by the noted test automation platforms in order to enable software testing operations (e.g., automated software testing operations). By reducing the number of processing operations that need to be performed by the noted test automation platforms in order to enable software testing operations, various embodiments of the present invention make important technical contributions to the field of software application testing. Furthermore, by enhancing the accuracy and reliability of test case data entities generated by test case developers, the user-friendly and intuitive test case generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### Annotation-Based Test Case Data Entities

In some embodiments, a test case data entity may be generated and/or modified using image annotation techniques described below. In some embodiments, once created using image annotation capture techniques described below, a created test case data entity may be modified using any of the techniques described herein for modifying test case data entities. While various embodiments of the present invention describe techniques for generating test case data entities using image annotation techniques described below, a person of ordinary skill in the relevant technology will recognize that the disclosed techniques can be used to modify an existing test case data entity by generating new test case page images and/or new test case steps for the existing test case data entity. In some embodiments, because the screen capture capabilities are tied to web browser based applications, the annotation-based test case design/modification capabilities enable generating test case data entities for desktop-based applications.

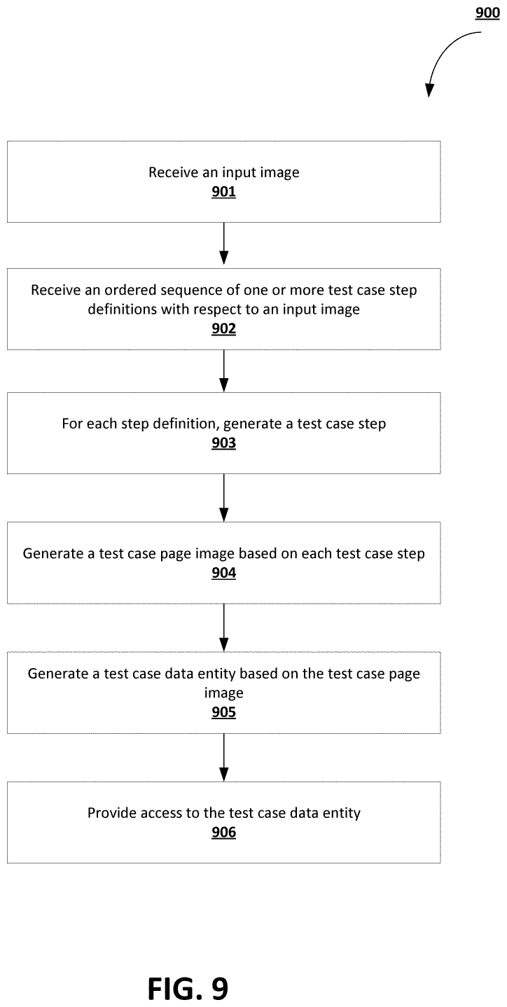

FIG. 9 is a flowchart diagram of an example process 900 for generating a test case data entity based at least in part on an input image (e.g., an uploaded image). Via the various steps/operations of the process 900, the web server computing entity 104 can utilize existing image data to efficiently generate test case page images for test case data entities, where the test case page images may in turn be used to generate test case visualizations.

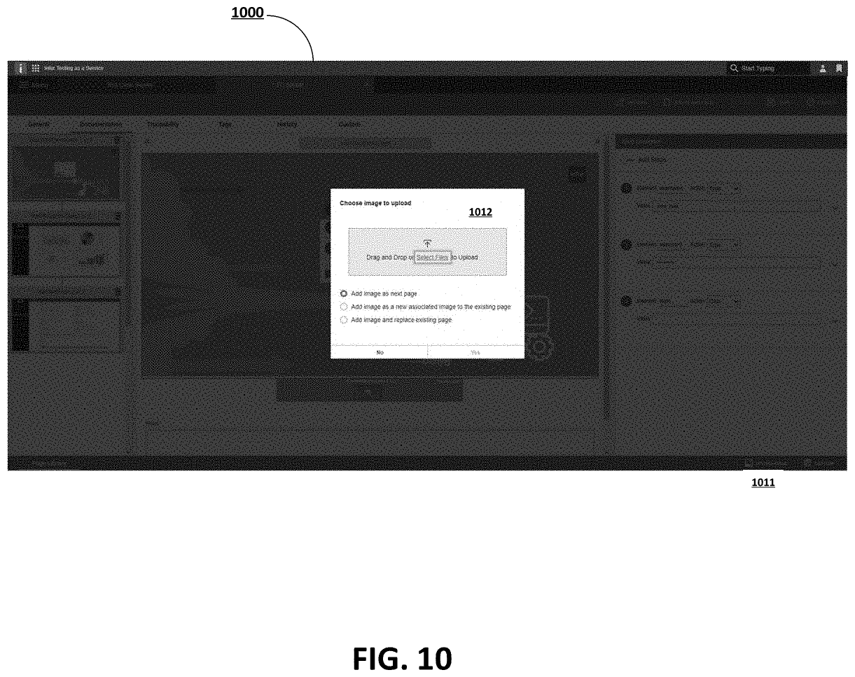

The process 900 begins at step/operation 901 when the web server computing entity 104 receives an input image. An example of an input image is an uploaded image, such as an uploaded image that depicts a visual state of a webpage associated with a test case. For example, as depicted in FIG. 10, user selection of the image upload button 1011 of the webpage 1000 displays the image upload page panel 1012 that enables uploading an input image as either a test case page image for a next webpage after the currently selected webpage, a new test case page image for the currently selected webpage, or to replace (e.g., across all of the test case documentation data associated with the webs server computing entity 104) the test case page images (e.g., references to test case page images) of the currently selected webpage. Other examples of input images include images selected from a local page library and/or captured page images generated using screen capture techniques described above.

At step/operation 902, the web server computing entity 104 receives an ordered sequence of one or more test case step definitions with respect to the input image. In some embodiments, the web server computing entity 104 receives the ordered sequence of test case step definitions from a client computing entity 102, and the client computing entity 102 generates the ordered sequence based at least in part on test case step definition operations performed by an end user of the client computing entity 102 while interacting with the input image. In some embodiments, a test case step definition can define a region of interest within the input image, where the region of interest is defined using user actions configured to “draw” a boundary in relation to the input image, and where the drawn boundary may only be used to define a region of interest when the drawn boundary has a threshold size (e.g., includes at least ten pixels).

A test case step definition may describe user-provided values for (i) the location of a visual element identifier for a test case step that is configured to be overlaid on an input image associated with the test case step, and (ii) one or more action features for a user action associated with the test case step, where both the location of the visual element identifier for the test case step and the one or more action features for the user action are determined based at least in part on values explicitly provided by an end user (rather than based at least in part on monitoring a captured session associated with the end user). Therefore, a test case step definition may be generated based at least in part on explicit test case step definition data provided by an end user, as opposed to implicit test case step definition data inferred based at least in part on a session data entity. A test case step definition may be associated with a position in an ordered sequence of test case step definitions associated with a corresponding image, where the position of a test case step definition within the noted ordered sequence may be determined based at least in part on a user action sequence identifier of the user action that is associated with the test case step for the test case step definition.

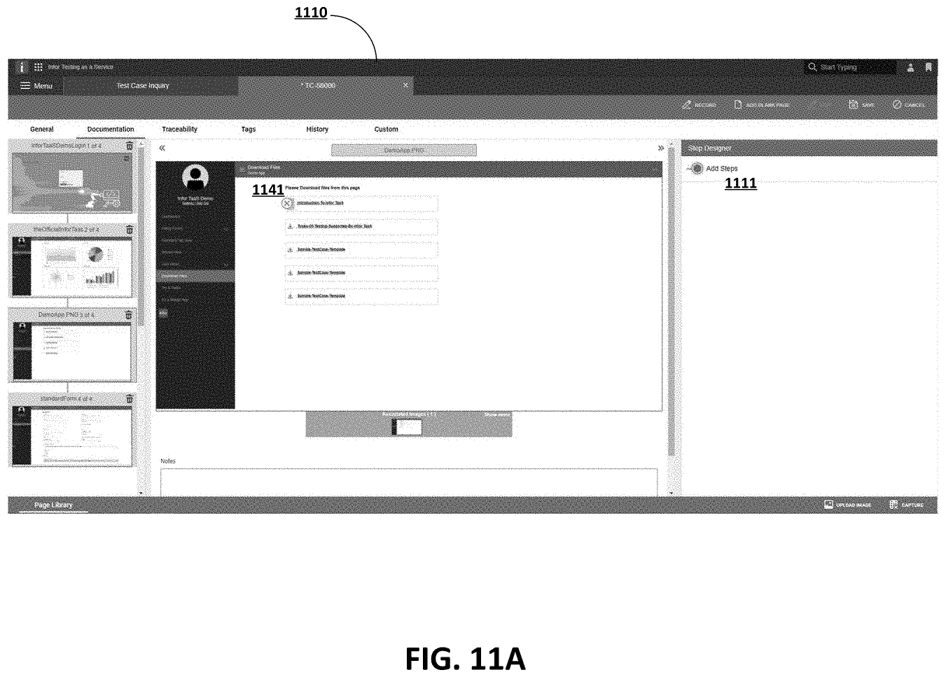

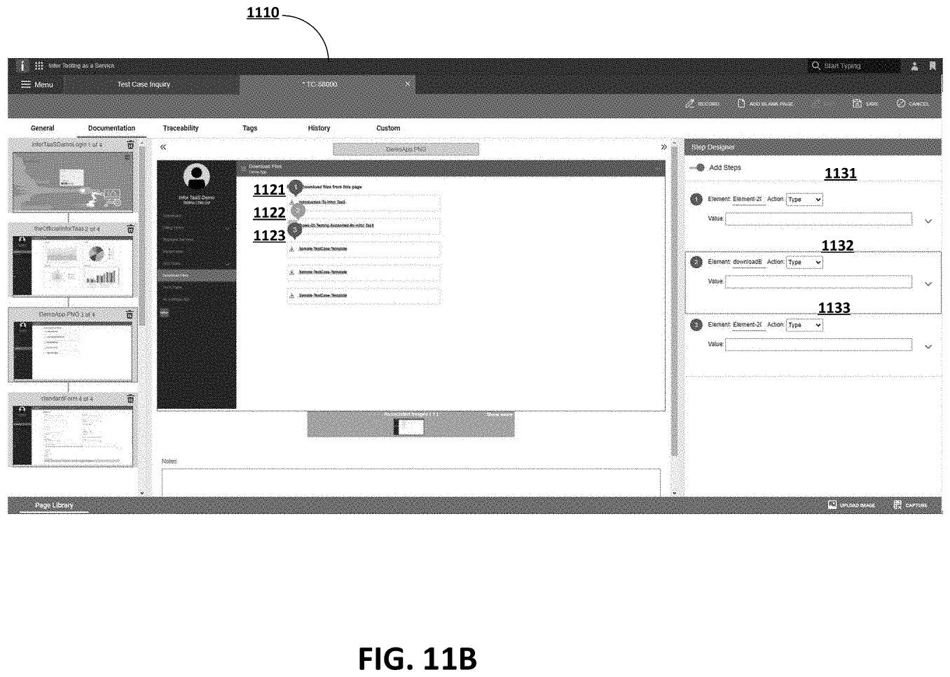

An operational example of user operations configured to define an ordered sequence of test case step definitions is depicted in FIGS. 11A-11B. As depicted in FIG. 11A, within the depicted webpage 1110, to define the ordered sequence of test case step definitions, an end user first selects the toggle button 1111 to enable defining test case steps, and then selects (e.g., via drag and drop operations to identify a user-defined element which was not previously located by a screen capture component and/or in accordance with the screen capture techniques described above) image region annotations for locations of visual element identifiers associated with the test case step definitions, such as the image region annotation 1141 associated with the first test case step definition. In some embodiments, the order in which the end user selects image region annotations defines the order of the corresponding test case step definitions. In some embodiments, the end user may optionally modify the test case steps by (for example) deleting, moving around, or resorting test case steps, and test case steps may be added in between existing steps. In any of these cases, the test case steps will automatically re-number accordingly. As depicted in FIG. 11B, subsequent to generating image region annotations, the end user selects (e.g., selects) visual element identifiers 1121, 1122, 1123 for the three test case step definitions to generate test case step action feature elements 1131, 1132, 1133 for the three test case step definitions, and then uses the test case step action feature elements 1131, 1132, 1133 to provide values for action features for the test cases. In some embodiments, the order in which the end user selects visual element identifiers defines the order of the corresponding test case step definitions.

At step/operation 903, the web server computing entity 104 generates a test case step for each test case step definition in the ordered sequence of test case step definitions based at least in part on the test case step definition. In some embodiments, the web server computing entity 104 generates a test case step for a test case step definition that describes: (i) the visual element identifier for the corresponding test case step definition, and (ii) the one or more action features for the test case step definition. As described above, a test case step may include data used to generate at least one of the following: (i) a visual element identifier that is configured to be overlaid on the test case page image in an overlay location associated with a region of the test case page image that corresponds to the interactive page element for the test case step, and (ii) a test case step action feature that describes one or more action features of the user action associated with the test case step. For example, if a test case step corresponds to the user action of selecting a particular button on a particular webpage, the test case step may describe data corresponding to a visual element identifier that is configured to be overlaid on an image region of a test case page image for the particular webpage that corresponds to a location of the particular button on the particular webpage.

At step/operation 904, the web server computing entity 104 generates a test case page image for the input image based at least in part on each test case step definition. In some embodiments, the web server computing entity 104 modifies the test case page image by overlaying the visual element identifiers associated with the test case steps to the test case page. As described above, the test case step may describe: (i) the visual element identifier for the corresponding test case step definition, and (ii) the one or more action features for the test case step definition. In some embodiments, on an uploaded test case page image, the user can define the boundary of each page element by drag and drop actions. In some embodiments, if the user is using a test case page image integrated from a test case page library and the test case page image is associated with existing element boundaries (e.g., created by the user or another user within the same project), the user may simply click within the element boundary to add the step identifier for a corresponding test case step.

At step/operation 905, the web server computing entity 104 generates the test case data entity based at least in part on the test case page image. In some embodiments, the web server computing entity 104 combines the test case page images for various webpages associated with a test case to generate the test case data entity for the noted test case. As described above, a test case data entity may in some embodiments be configured to describe: (i) one or more test case page images associated with the test case, and (ii) for each test case page image of the one or more test case page images, a set of test case steps that relate to the test case page image. In some embodiments, the test case data entity contains data that can be used to generate a test case visualization user interface for the test case associated with the test case data entity, such as a test case visualization user interface that depicts: (i) one or more test case page images associated with the test case, and (ii) for each test case page image of the one or more test case page images, a set of test case visualizations corresponding to each test case step in the set of test case steps that relate to the particular test case page image.

At step/operation 906, the web server computing entity 104 provides the test case data entity using a test case visualization user interface. In some embodiments, the web server computing entity 104 generates a test case visualization user interface data object for the test case visualization user interface and provides the test case visualization user interface data object to a client computing entity 102, where the client computing entity 102 is configured to present a test case visualization user interface to an end user based at least in part on the test case visualization user interface data object. In some embodiments, test case data entities can be converted to different file formats, such as printed to a Portable Document Format (PDF) file.

The above-described techniques for generating image-annotation-based test case data entities are configured to provide test case generation techniques that are more user-friendly and intuitive. The user-friendly and intuitive test case generation techniques enhance the accuracy and reliability of test case data entities generated by test case developers, which in turn reduces the number of erroneous testing operations (e.g., erroneous automated testing operations) that are performed. Reducing the number of erroneous testing operations improves the operational efficiency of test automation platforms by reducing the number of processing operations that need to be performed by the noted test automation platforms in order to enable software testing operations (e.g., automated software testing operations). By reducing the number of processing operations that need to be performed by the noted test automation platforms in order to enable software testing operations, various embodiments of the present invention make important technical contributions to the field of software application testing. Furthermore, by enhancing the accuracy and reliability of test case data entities generated by test case developers, the user-friendly and intuitive test case generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### Dynamic Test Case Data Entity Cloning

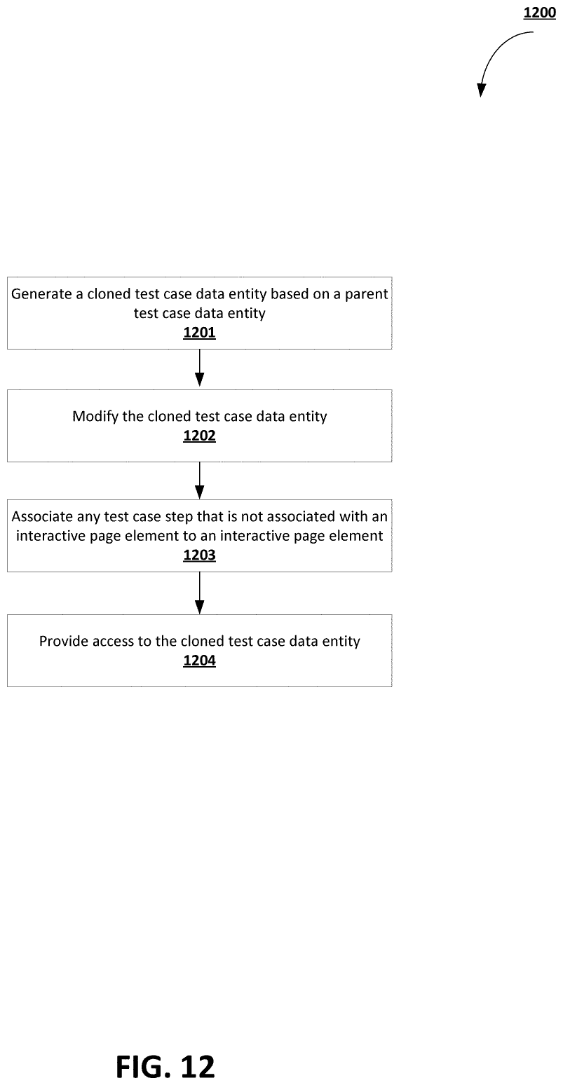

FIG. 12 is a flowchart diagram of an example process 1200 for dynamically cloning (i.e., integrating) a parent test case data entity into a local test case library. Via the various steps/operations of the process 1200, the web server computing entity 104 enables both using existing test case data entities into parent test case libraries to generate cloned test case data entities as well as modifying cloned test case data entities. However, while various embodiments of the present invention describe cloning of test case data entities and modifying of test case data entities in combination, a person of ordinary skill in the relevant technology will recognize that: (i) a cloned test case data entity may be utilized without any modifications, and (ii) an existing test case data entity that is not a cloned test case data entity may be modified in accordance with the techniques described herein.

A parent test case data entity that is cloned may or may not be associated with a test automation workflow data entity. Enabling cloning of parent test case data entities that are not associated with test automation workflow data entities may allow the user to enhance the parent test case library by completing the automation capabilities of the parent test case data entity and then publish the completed test case data entity to the parent test case library. Moreover, in some cases, there may be test case data entities which cannot lend themselves to test automation and are better performed manually, but can nevertheless be cloned for manual automation.

The process 1200 begins at step/operation 1201 when the web server computing entity 104 generates a cloned test case data entity based at least in part on a parent test case data entity. In some embodiments, the web server computing entity 104 clones a parent test case data entity that exists in a parent test case library (which may be any predefined set of test case data entities that are available for cloning) in order to generate the cloned test case data entity.

In some embodiments, a parent test case data entity describes a test case data entity stored on a parent test case library that can be cloned into a local test case library. The parent test case data entity may, in some embodiments, comprise a set of references to a set of source test case page images, where each source test case page image may in some cases be associated with a hashed representation of an address identifier of the corresponding webpage associated with the source test case page image. In some embodiments, if a parent test case data entity is associated with a set of captured page images and a set of uploaded input images, then the set of captured images may be associated with hashed representations of their corresponding address identifiers. In some of the noted embodiments, the parent test case data entity may include a reference to each test case page image associated with the parent test case data entity and/or to each nestable test case data entity associated with the parent test case data entity, including both to the set of captured page images and the set of uploaded images. For example, consider a parent test case data entity that is associated with captured page images C1 and C2 that are associated with webpages W1 and W2 as well as the uploaded image I1. In the noted example, the parent test case data entity may include (i) references to C1, C2, and I1, and (ii) hashed representations of address identifiers (e.g., URLs) of W1 and W2. As an example, if TC1 includes TC2 and TC2 includes TC3, by cloning TC1, the web server computing entity 104 may also include TC2 and TC3 data as TC1 gets cloned to the local library. In this case, all 3 test cases would be cloned instead of simply TC1.

A cloned test case data entity may describe a test case data entity that is generated by cloning a parent test case data entity into a local test case library. In some embodiments, a cloned test case data entity that is generated based at least in part on a parent test case data entity comprises, for each test case page image of the parent test case data entity whose corresponding hashed representation is found among the hashed representations of a group of local test case page images in a local page image repository of the local test case library, the reference to a local test case page image in the local page image repository whose hashed representation corresponds to the hashed representation of the test case page image in the parent test case data entity. For example, consider an exemplary parent test case data entity that includes a first test case page image T1 that is associated with the hashed representation H1, a second test case page image T2 that is associated with the hashed representation H2, and a third test case page image that is not associated with a hashed representation. In the noted examples, if the local page image repository for the local test case library includes a test case page image D1 that corresponds to the hashed representation H1 but does not include any test case page images that correspond to the hashed representation H2, then the cloned test case data entity may include a reference to D1 for the webpage corresponding to the hashed representation H1 but no references for the webpage corresponding to the hashed representation H2.

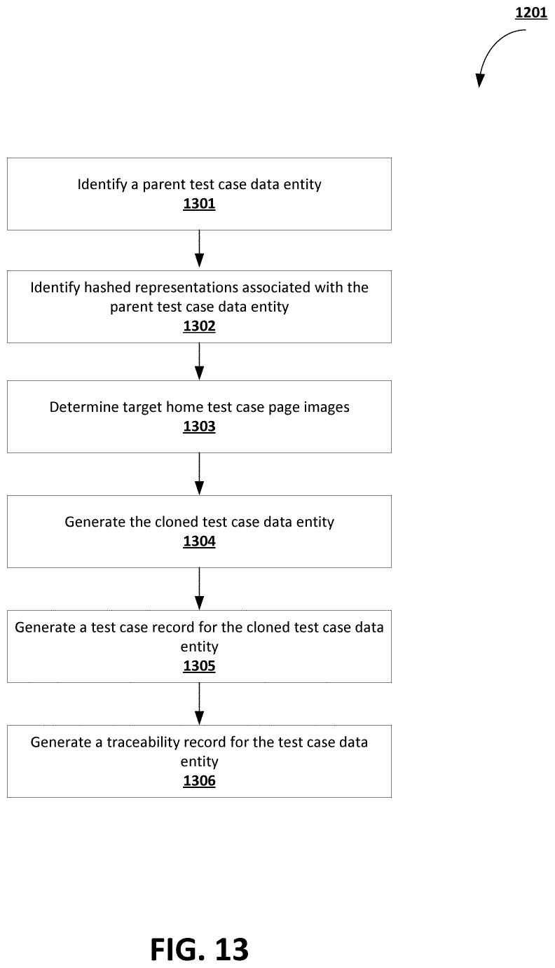

In some embodiments, step/operation 1201 may be performed in accordance with the process that is depicted in FIG. 13. The process that is depicted in FIG. 13 begins at step/operation 1301 when the web server computing entity 104 identifies a parent test case data entity. In some embodiments, the parent test case data entity is a test case data entity associated with a parent test case library, where the parent test case library may include a collection of test case data entities that may be used to generate cloned test case data entities in a parent test case library. In some embodiments, the web server computing entity 104 is configured to publish the parent test case data entity by uploading a test case data entity stored on a local/internal test case library into a global/external test case library.

In some embodiments, the web server computing entity 104 identifies the parent test case data entity when an end user selects the parent test case data entity. In some embodiments, as part of identifying the parent test case data entity, the web server computing entity 104 determines whether the parent test case library is a test case library from which test case cloning may be performed (e.g., determines whether the parent test case library is a global/external test case library or a local/local test case library). If the web server computing entity 104 determines that the parent test case data entity is not a test case library from which test case cloning may be performed, the web server computing entity 104 may generate a prompt noting that the selected parent test case data entity cannot be cloned.

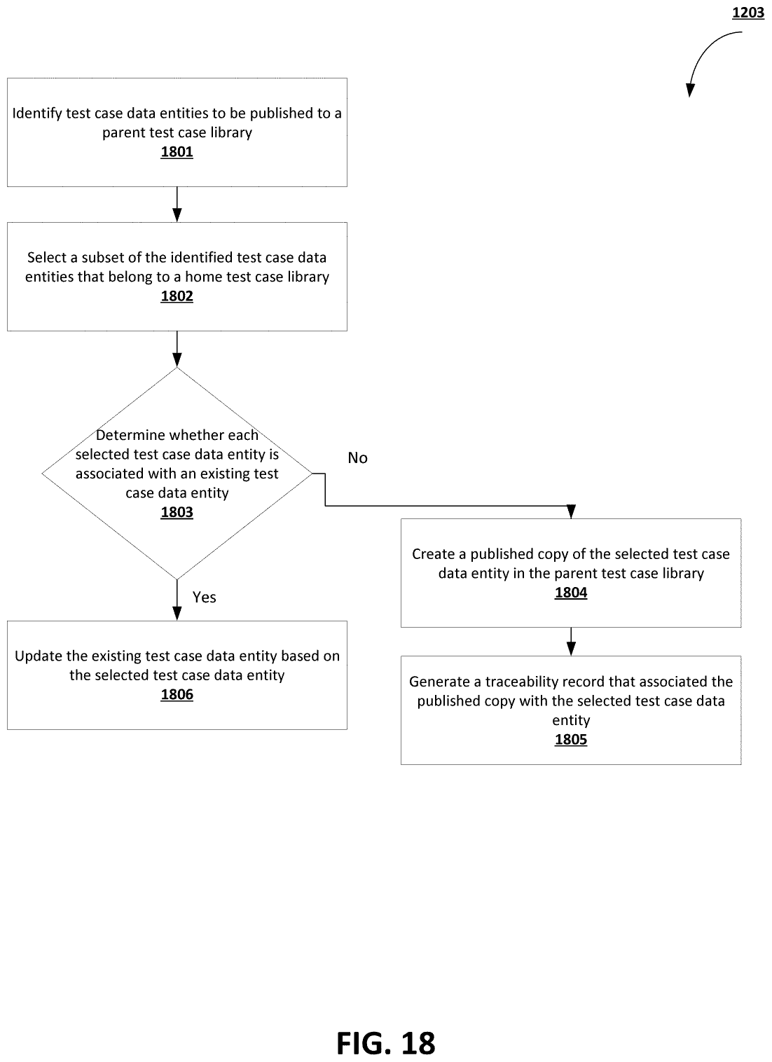

In some embodiments, step/operation 1301 may be performed in accordance with the process that is depicted in FIG. 18. The process that is depicted in FIG. 18 begins at step/operation 1801 when the web server computing entity 104 identifies one or more test case data entities that are selected to be published to a parent test case library. For example, the web server computing entity 104 may display to a client computing entity 102 a list of test case data entities, from which the end user may select one or more test case data entities for “publication” into the parent test case library. In some embodiments, the one or more test case entities may be identified from a set of test case data entities satisfying certain search criteria entered by an end user, such as satisfying certain search criteria defined by classification tags, modification date, name, and/or the like. In some embodiments, the user-selected test case data entities may be selected from a set of test case data entities recently viewed or otherwise interacted with by the end user. In embodiments where one or more parent test libraries may exist, step/operation 1801 may further comprise identifying a parent test case library from the one or more parent test case libraries to which the one or more test case data entities are to be published.

At step/operation 1802, the web server computing entity 104 selects a subset of the identified test case data entities that belong to a local test case library associated with the end user. In some embodiments, the web server computing entity 104 may not select test case data entities that belong to a parent test case library already and/or that do not belong to a local test case library of the end user. Those of skill in the art will appreciate that step/operation 1802 may in some embodiments prevent test case data entities that are not deemed to belong to an end user to be published by the end user.

At step/operation 1803, the web server computing entity 104 determines whether each selected test case data entity is associated with an existing test case data entity in the parent test case library. In some embodiments, this determination may comprise identifying metadata associated with the selected test case data entity such as an identification number of the selected test case data entity, a version number of the selected test case data entity, and/or the like. For example, in some embodiments, the web server computing entity 104 may identify an identification number for the selected test case data entity and determine whether the identified identification number is the same as an identification number of any existing test case data entity already in the parent test case library. It will be appreciated by those of skill in the art that each test case data entity may be associated with multiple identification numbers, and the aforementioned determinations may be performed using globally or universally based identification numbers that are uniquely maintained across the multiple local libraries and one or more parent test case libraries.

If the web server computing entity 104 determines that the selected test case data entity is not associated with any existing test case data entities in the parent test case library, then step/operations 1804-1805 are performed. At step/operation 1804, the web server computing entity 104 creates a published copy of the selected test case data entity in the parent test case library. In some embodiments, creating a published copy of the selected test case data entity may comprise copying data contained in and metadata associated with the selected test case data entity. In embodiments, the published copy of the selected test case data entity in the parent test case library may be associated with the same global or universal identification number/identifier as the selected test case data entity.

At step/operation 1805, the web server computing entity 104 generates a traceability record that associates the published copy with the selected test case data entity. The traceability record may describe that the published copy originated from a publishing action on the selected test case data entity and include identification numbers/identifiers associated with the selected test case data entity for reference. The traceability record may further include metadata such as version number(s) associated with the selected test case data entity and/or associated with the published copy, the publishing date/time of the publication, an identifier for the end user requesting the publication, and/or the like. The traceability record may be stored in a location associated with the published copy. In certain embodiments, the traceability record may also be stored as part of the selected test case data entity.

If the web server computing entity 104 determines that the selected test case data entity is associated with an existing test case data entity in the parent test case library, at step/operation 1806, the web server computing entity 104 updates the existing test case data entity based at least in part on the selected test case data entity. In some embodiments, the existing test case data entity may be modified so that the data contained in the existing test case data entity substantially matches or is substantially equal to the data contained in the selected test case data entity. In some embodiments, the updating of the existing test case data entity may comprise incrementing or otherwise modifying a version number of the existing test case data entity. In some embodiments, a traceability record may be generated, using techniques substantially similar to the techniques described in step/operation 1805. It will be appreciated by those of skill in the art that, because the existing test case data entity exists in the parent test case library, it is possible that it had been previously published and contains one or more traceability records. As such, a generated traceability record may append existing traceability records.

At step/operation 1302, the web server computing entity 104 identifies one or more hashed representations of one or more parent test case page images in the parent test case data entity. In some embodiments, the web server computing entity 104 identifies a selected subset of the test case page images in the parent test case data entity, wherein each test case page image in the selected subset has a hashed representation of its corresponding webpage address, and generates the one or more hashed representations based at least in part on each hashed representation for a test case page image in the selected subset. In some embodiments, a test case page image is associated with a hashed representation if it has been generated based at least in part on a captured page image that has been obtained during a captured session of an end user, in accordance with the techniques described above in relation to captured test case data entities.

At step/operation 1303, the web server computing entity 104 determines one or more target local test case page images in a local page image repository of the local test case library that are associated with the one or more hashed representations identified at step/operation 1302. In some embodiments, to determine the one or more target local test case page images, the web server computing entity 104 maps each hashed representation identified at step/operation 1302 to a set of local test case pages images in the local page image repository (including to an empty set of local test case page images, if a hashed representation is not found among any of the hashed representations of the local test case page images in the local page image repository), and then combines each set of local test case page images for an identified hashed representation to generate the one or more target local test case page images.

At step/operation 1304, the web server computing entity 104 generates the cloned test case data entity based at least in part on the one or more target local test case page images. In some embodiments, to generate the cloned test case data entity, the web server computing entity 104 generates a test case data entity comprising a reference to each of the one or more target local test case page images. In some embodiments, if at the time of generating the cloned test case data entity, the local test case library contains a corresponding copy of the parent test case data entity in the local test case library, then the web server computing entity 104 may update the corresponding copy to reflect the cloned test case data entity. In some embodiments, if at the time of generating the cloned test case data entity, the local test case library does not contain a corresponding copy of the parent test case data entity in the local test case library, then the web server computing entity 104 may create a copy of the parent test case data entity based at least in part on the cloned test case data entity. In some embodiments, subsequent to generating the cloned test case data entity, the web server computing entity 104 modifies the status of the cloned test case data entity to cloned.

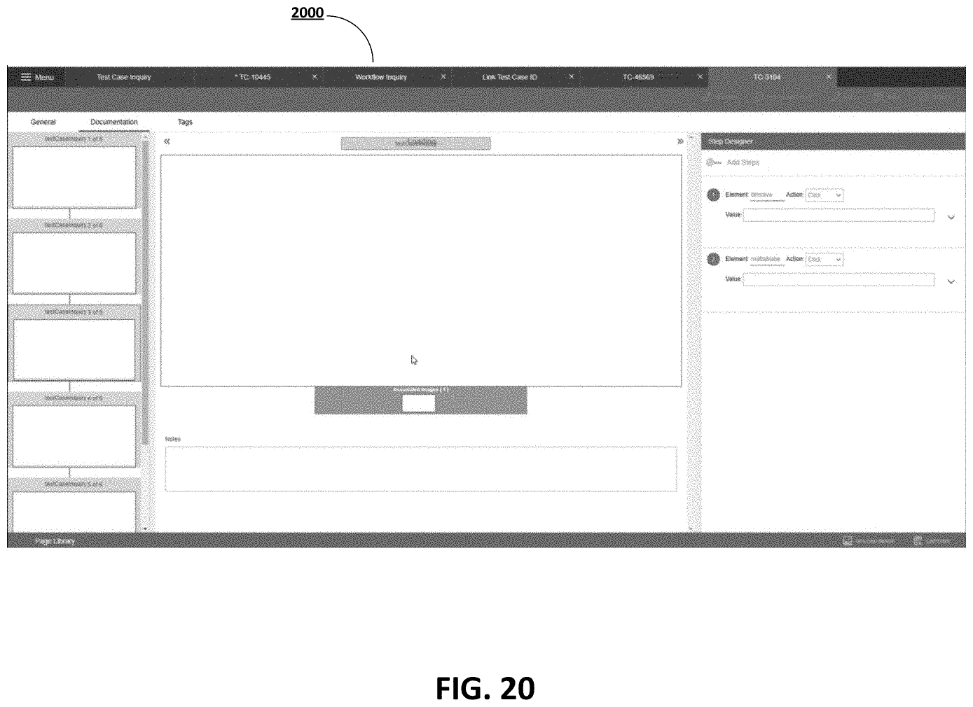

In some embodiments, generating the cloned test case data entity using a reference to each parent test case page image causes a test case visualization user interface that corresponds to the cloned test case data entity to depict: (i) locally-stored test case page images for those test case page images in the parent test case data entity whose hashed representations exist in the hashed representations of the test case page images in a local test case library, and (ii) blank/null test case page images for those test case page images in the parent test case data entity whose hashed representations do not exist in the hashed representations of the test case page images in a parent test case library. For example, as depicted in the test case visualization user interface 2000 that is depicted in FIG. 20, the first four webpages of the corresponding cloned test case data entity are associated with blank/null test case page images, because the hashed representations of the noted four webpages were not found among the hashed representation of local test case page images in a local page image repository.

In some embodiments, a cloned test case data entity does not describe the user input values of the test case steps associated with the parent test case data entity. For example, as depicted in the test case visualization user interface 2000, none of the test case steps of the corresponding cloned test case data entity include user input values of the corresponding parent test case data entity.

In some embodiments, a cloned test case data entity comprises (i) for each test case page image of the parent test case data entity whose hashed representation corresponds to the hashed representation of at least one test case page image in a local page image repository, the at least one test case page image and masked test case steps described by the parent test case data entity for the test case page image, and (ii) for each test case page image of the parent test case data entity whose hashed representation does not correspond to the hashed representation of at least one test case page image in a local page image repository, a null/blank image and masked test case steps described by the parent test case data entity for the test case page image. In some embodiments, a masked test case step is a test case step that is modified in accordance with one or more data masking operations, where defined categories of data associated with the test case step (e.g., the user input value for the test case step) have been removed and/or rendered inaccessible as a result of the noted one or more data masking operations.

For example, consider a parent test case data entity that is associated with a first test case page image S1 for a first webpage having the hashed representation H1 and a second test case page image S2 for a second webpage having the hashed representation H2. Assume further that S1 is associated with the user action of inputting “Hello” into a first textbox within the first webpage and selecting a submit button within the first webpage, while S2 is associated with the user action of inputting “Goodbye” into a second textbox within the second webpage. If a user selects to clone the parent test case data entity into a local test case library, assuming that a parent page image repository for the parent test case library includes a test case page image D1 corresponding to the first webpage (and thus having the hashed representation H1) but no test case page images corresponding to the second webpage (and thus having the hashed representation H2), then the cloned test case data entity may describe/depict: (i) the test case page image D1 along with a first test case step corresponding to inputting a value into the first textbox and a second test case step corresponding to selecting the submit button but without describing the user input value of “Hello” for the first test case step as the test case step will be a masked test case step, and (ii) a blank/null test case page image along with the test case step of inputting a value into the second textbox but without describing the user input value of “Goodbye” for the first test case step as the test case step will be a masked (e.g., blank) test case step.

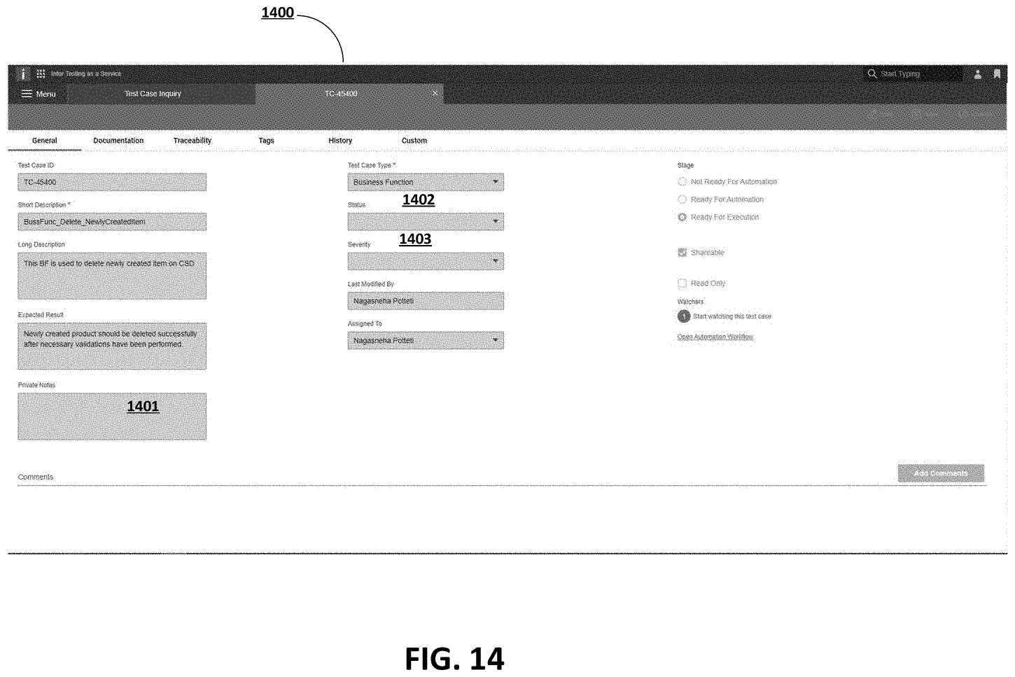

At step/operation 1305, the web server computing entity 104 generates a test case record for the cloned test case data entity that describes non-private fields of a test case record of the parent test case data entity. For example, as depicted in FIG. 14, the test case visualization user interface 1400 does not include any values for private fields 1401-1403, as those values are not cloned into the cloned test case data entity. In some embodiments, the configuration data for the web server computing entity 104 defines which data fields associated with a test case data entity are deemed to be private and which fields associated with a test case data entity are deemed to be non-private.

At step/operation 1306, the web server computing entity 104 generates a traceability record for the cloned test case data entity, such as a traceability record that describes at least one of an identifier of the parent test case data entity for the cloned test case data entity, a short description of the test case data entity cloning, a link to the parent test case data entity, a cloning date/time of the test case entity data cloning, and a user identifier of the user profile who performed the test case data entity cloning.

Returning to FIG. 12, at step/operation 1202, the web server computing entity 104 modifies the cloned test case data entity. In some embodiments, modifying the cloned test case data entity comprises adding one or more test case page images to the cloned test case data entity. In some embodiments, the one or more test case page images are added as the test case page images for a new webpage associated with the test case data entity. In some embodiments, the one or more test case page images are added as new test case page images for an existing webpage associated with the test case data entity to supplement existing test case page images for the existing webpage. In some embodiments, the one or more test case page images are added as replacements for existing test case page images for an existing webpage associated with the test case data entity.

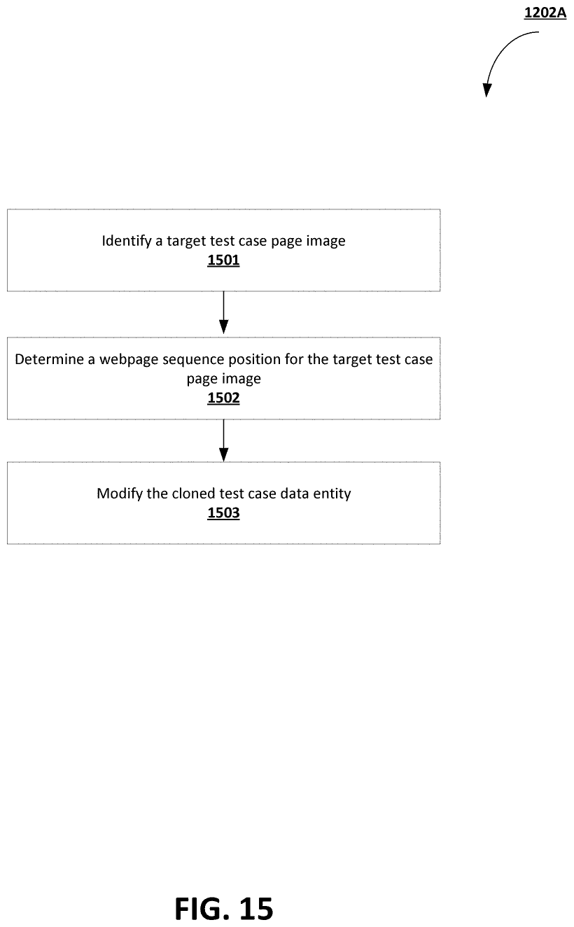

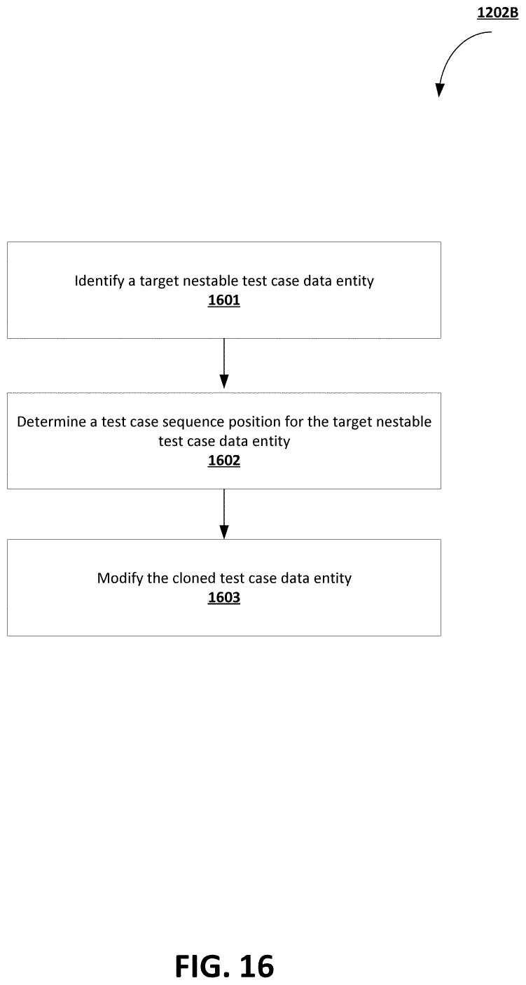

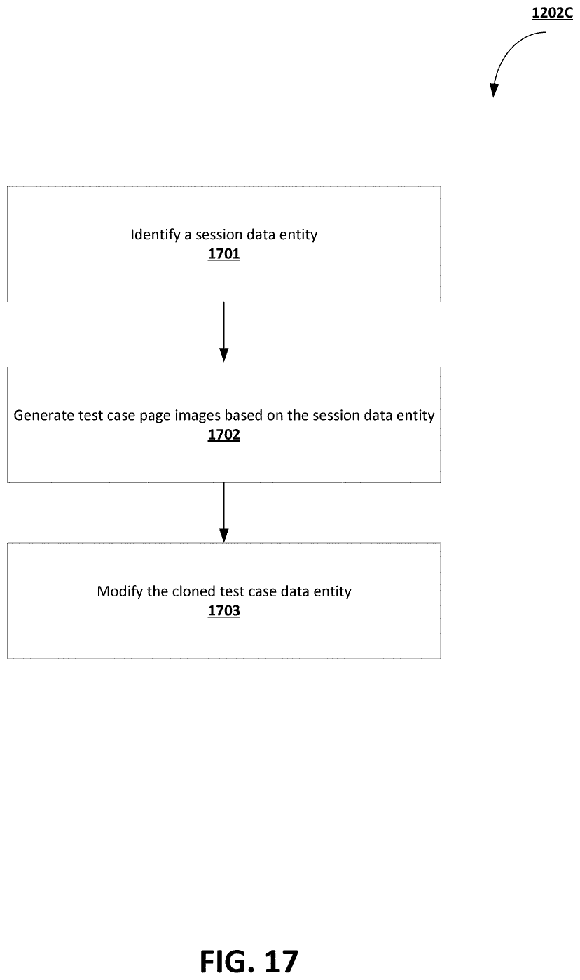

In some embodiments, step/operation 1202 can be performed in accordance with one or more of the: the process 1202A that is depicted in FIG. 15, the process 1202B that is depicted in FIG. 16, and the process 1202C that is depicted in FIG. 17.

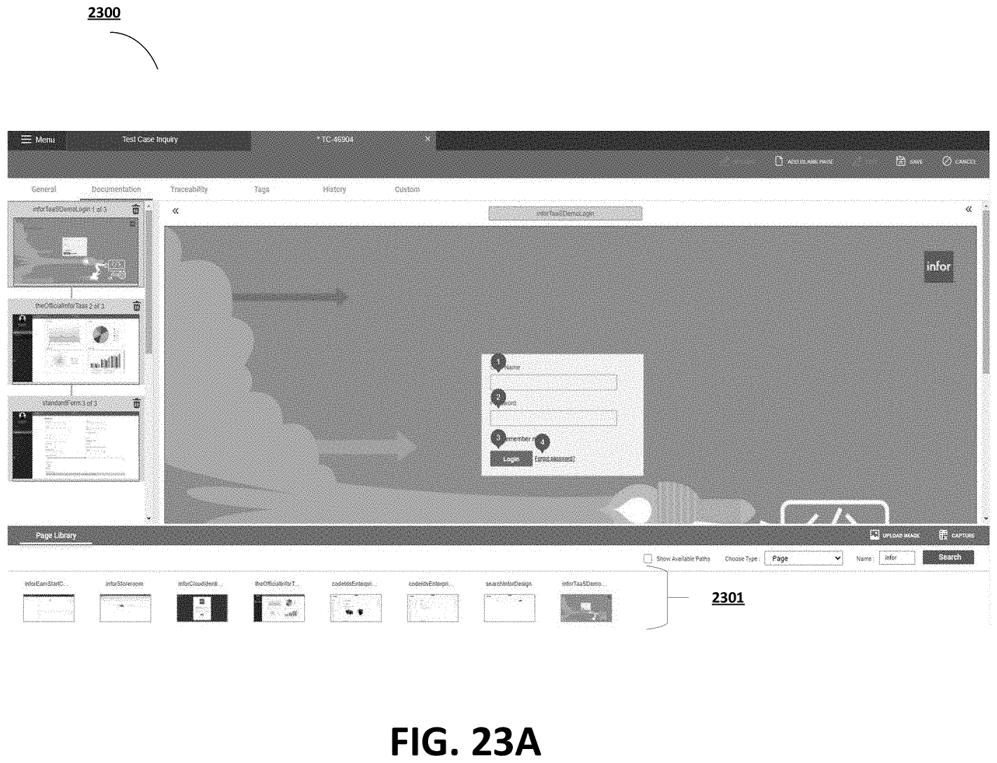

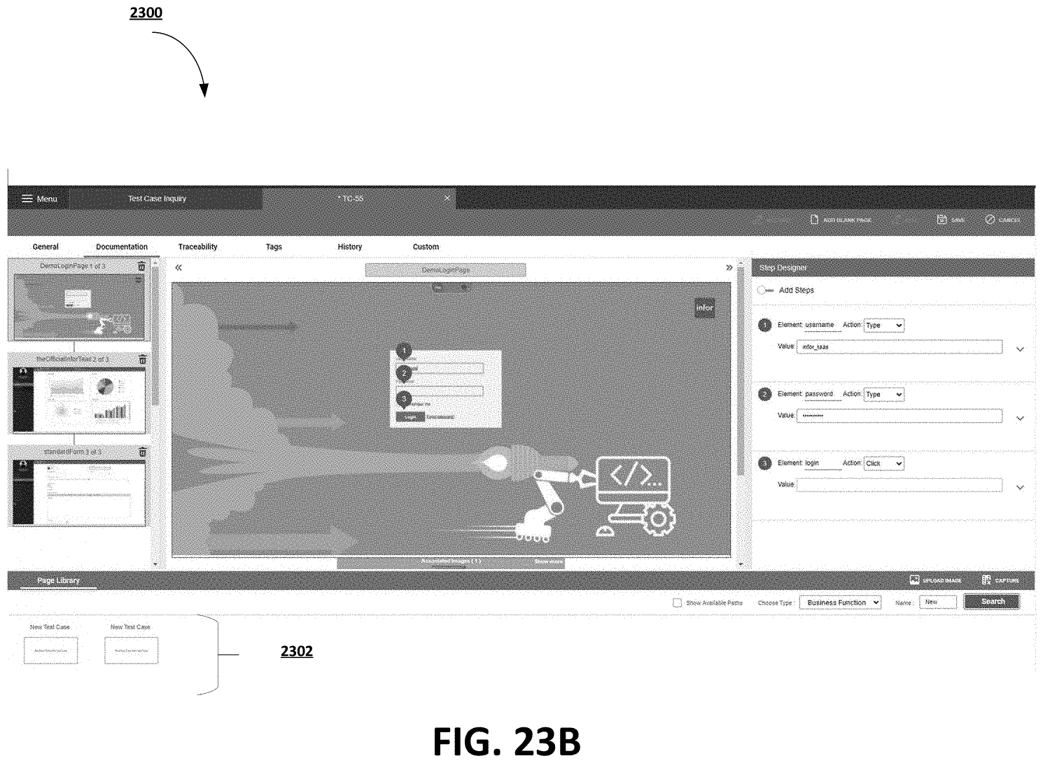

In some embodiments, step/operation 1202 is performed in accordance with the process 1202A that is depicted in FIG. 15, which is a process of adding a selected existing test case page image in a local page image repository of a local page test case library associated with a user profile as a test case page image for a new webpage. The process 1202A begins at step/operation 1501 when the web server computing entity 104 identifies a target test case page image within the local page image repository. In some embodiments, the user performs a keyword search of the existing test case page images to detect a target test case page image, and then proceeds to select the target test case page image. In some embodiments, the user searches the local page image repository to detect test case page images deemed related to a selected webpage of a test case visualization user interface, detects a target test case page images from the related test case page images, and then proceeds to select the target test case page image. In some embodiments, the user searches the local page image repository to detect test case page images deemed related to a selected webpage of a test case visualization user interface, performs keyword search on the related test case page images to detect a target test case page image, and then proceeds to select the target test case page image. An operational example of a test case visualization user interface with a test case page search output 2301 is depicted in the test case visualization user interface 2300 of FIG. 23A.

At step/operation 1502, the web server computing entity 104 determines a webpage sequence position for the target the test case page image within the cloned test case data entity. The webpage sequence position may describe the position in a sequence of webpages associated with the cloned test case data entity at which the new webpage associated with the test case page image is added. In some embodiments, to select the target test case page image, the user drags and drops the target test case page image into a thumbnail panel of the test case visualization user interface, where the drop location of the drag and drop may determine the position of the corresponding webpage associated with the target test case page image in a sequence of webpages dictated by the noted cloned test case data entity.

At step/operation 1503, the web server computing entity 104 modifies the cloned test case data entity based at least in part on the webpage sequence position and the target test case page image. In some embodiments, the web server computing entity 104 integrates the target test case page image into the cloned test case data entity by adding the target test case page image to a new webpage placed according to the webpage sequence position.

In some embodiments, step/operation 1202 is performed in accordance with the process 1202B that is depicted in FIG. 16, which is an example process of adding a nestable test case data entity into the cloned test case data entity as a set of test case page images for a set of new webpages. The process 1202B begins at step/operation 1601 when the web server computing entity 104 identifies a target nestable test case data entity. In some embodiments, to identify a target nestable test case data entity, a user performs a target nestable test case data entity search based at least in part on a number of search values (e.g., keyword search values) within a local test case library to identify the target nestable test case data entity. An operational example of a test case visualization user interface with a nestable test case search output 2302 is depicted in the test case visualization user interface 2300 of FIG. 23A.

A nestable test case data entity (aka. a business function) may be a test case data entity that can be integrated as a unit within another test case data entity, where any modifications of the nestable test case data entity causes corresponding modifications for any test case data entity that has integrated the nestable test case data entity. In some embodiments, a nestable test case data entity may describe a sequence of test case page images each potentially associated with a set of test case steps. An example of a nestable test case data entity is a business function that describes test case steps associated with a test for logging into a software system using particular authentication credentials. In some embodiments, a nestable test case data entity may itself include one or more nestable test case data entities.

At step/operation 1602, the web server computing entity 104 identifies a test case sequence position for the target nestable test case data entity within the cloned test case data entity. The test case sequence position may describe a position of one or more webpages associated with the nestable test case data entity within a sequence of webpages associated with the cloned test case data entity. In some embodiments, to select the target nestable test case data entity, the user drags and drops the target nestable test case data entity into a thumbnail panel of the test case visualization user interface, where the drop location of the drag and drop may determine the position of the corresponding webpage(s) associated with the target nestable test case data entity in a sequence of webpages dictated by the noted cloned test case data entity.

At step/operation 1603, the web server computing entity 104 modifies the cloned test case data entity based at least in part on the test case sequence position and the target nestable test case data entity. In some embodiments, the web server computing entity 104 integrates the target test case data entity into the cloned test case data entity by adding the webpages associated with the target nestable test case data entity as new webpages placed according to test case sequence position.

In some embodiments, step/operation 1202 is performed in accordance with the process 1202C that is depicted in FIG. 17, which is an example process for adding one or more new test case page images determined based at least in part on a session data entity into a cloud test case data entity as a set of test case page images for a set of new webpages. The process 1202C that is depicted in FIG. 17 begins at step/operation 1701 when the web server computing entity 104 identifies a session data entity associated with a cloned test case data entity. In some embodiments, a user selects to record a session, the web server computing entity 104 enables capturing the session, and then the web server computing entity 104 uses the session to generate the session data entity.

At step/operation 1702, the web server computing entity 104 generates the one or more test case page images based at least in part on the session data entity. In some embodiments, the web server computing entity 104 generates the one or more test case page images based at least in part on the one or more captured page images described by the session data entity. In some embodiments, in addition to the one or more test case page images, the web server computing entity 104 generates one or more test case steps based at least in part on the session data entity. In some embodiments, the web server computing entity 104 generates a capture position for the session data entity within a sequence of webpages associated with the cloned test case data entity based at least in part on a position of the user within the sequence of webpages at the time of requesting the screen capture session, and then uses the capture position to determine a test case sequence position for the webpage(s) described by the test case page images within a sequence of webpages associated with the cloned test case data entity.

At step/operation 1703, the web server computing entity 104 modifies the cloned test case data entity based at least in part on a test case sequence position associated with the session data entity and the one or more test case page images. In some embodiments, the web server computing entity 104 integrates the one or more test case page images into the cloned test case data entity by adding the webpages associated with the one or more test case page images as new webpages placed according to the test case sequence position.

At step/operation 1203, the web server computing entity 104 associates an interactive page element to a test case step of the cloned test case data entity that is not associated with an interactive page element. In some embodiments, via the step/operation 1203, the web server computing entity 104 can associate a test case step of the cloned test case data entity that is not associated with an interactive page element with a spy object.

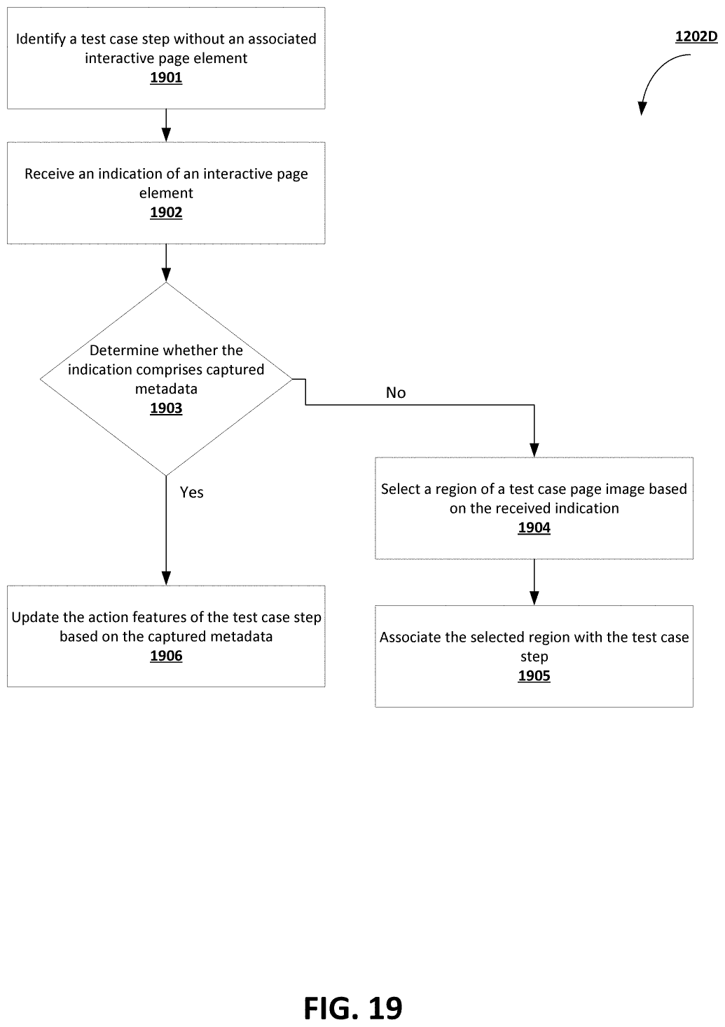

In some embodiments, step/operation 1203 may be performed in accordance with the process that is depicted in FIG. 19. The process that is depicted in FIG. 19 begins at step/operation 1901 when the web server computing entity 104 identifies a test case step without an associated interactive page element. In so embodiments, the web server computing entity 104 may identify test case steps without an associated interactive page element after the client computing entity 102 enables an end user of the client computing entity 102 to edit the test case data entity. In some embodiments, the web server computing entity 104 may identify test case steps repeatedly after at a predetermined period of time.

At step/operation 1902, the web server computing entity 104 receives an indication of an interactive page element from a client computing entity 102. The indication of an interactive page element may be relative to a test case page image. In some embodiments, the test case page image may comprise one or more interactive page elements captured during a session of an end user. For example, the one or more captured interactive page elements may be web elements in an HTML5 environment and may comprise captured metadata such as page coordinates, element identifier/name, element actions, and/or the like. In some embodiments, the indication of an interactive page element may be an indication that an end user has clicked on the interactive page element, and the indication may comprise the captured metadata. In some embodiments, the test case page image may not comprise any captured interactive page elements and may be an image file (e.g., a JPG, PNG, BMP, TIFF file) such as a screenshot of a webpage. An indication of an interactive page element in this test case page image may comprise an image region of pixels. For example, an end user may select an image region of a screenshot of a webpage where an interactive page element in the webpage may be located, without any captured metadata.

At step/operation 1903, the web server computing entity 104 determines whether the indication of an interactive page element comprises captured metadata. If the web server computing entity 104 determines that the indication of an interactive page element does not comprise captured metadata, then steps/operations 1904-1905 may be performed. At step/operation 1904, the web server computing entity 104 selects a region of a test case page image based at least in part on the received indication. At step/operation 1905, the web server computing entity 104 associates the selected region of the test case page image with the test case step. The selected region may be interpreted as an indication of an interactive page element, thus enabling the association of the test case step to an interactive page element.

If the web server computing entity 104 determines that the indication of an interactive page element comprises captured metadata, then at step/operation 1906, the web server computing entity 104 updates (e.g., overwrites the test case data entity describing) the action features of test case step based at least in part on the captured metadata. The captured metadata may include information about location and/or webpage of the interactive page element associated with the test case step.

At step/operation 1204, the web server computing entity 104 provides the cloned test case data entity using a test case visualization user interface. In some embodiments, the web server computing entity 104 generates a test case visualization user interface data object for the cloned test case visualization user interface and provides the test case visualization user interface data object to a client computing entity 102, where the client computing entity 102 is configured to present a test case visualization user interface to an end user based at least in part on the test case visualization user interface data object.

The above-described techniques for generating dynamically cloned test case data entities are configured to provide test case generation techniques that are more user-friendly and intuitive. The user-friendly and intuitive test case generation techniques enhance the accuracy and reliability of test case data entities generated by test case developers, which in turn reduces the number of erroneous testing operations (e.g., erroneous automated testing operations) that are performed. Reducing the number of erroneous testing operations improves the operational efficiency of test automation platforms by reducing the number of processing operations that need to be performed by the noted test automation platforms in order to enable software testing operations (e.g., automated software testing operations). By reducing the number of processing operations that need to be performed by the noted test automation platforms in order to enable software testing operations, various embodiments of the present invention make important technical contributions to the field of software application testing. Furthermore, by enhancing the accuracy and reliability of test case data entities generated by test case developers, the user-friendly and intuitive test case generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

In some embodiments of the present invention, if the element locator on the captured page image associated with a parent test case library is different from the captured page image in the destination test case library due to capture resolution variations, the element locator would be properly aligned once the web server computing entity 104 applies specific image scaling logics. In some embodiments, the user experience will be unaffected if a first user views the test case image in one resolution versus another user who views the same test case in another resolution. In both cases, the web server computing entity 104 will scale the image and associated element locators appropriately. In some embodiments, this same image scaling logic is also applied when the user opens/closes the page thumbnail panel 424 and/or the step designer panel 426.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a test case data entity, the computer-implemented method comprising:
receiving, using one or more processors and originating from a client computing entity, an ordered sequence of one or more test case step definitions for an input image, wherein each test case step definition is associated with (i) a visual element identifier location within the input image, and (ii) one or more action features;
for each test case step definition, generating, using the one or more processors, a test case step of an ordered sequence of test case step definitions based at least in part on the visual element identifier location for the test case step definition and the one or more action features for the test case step definition;
generating, using the one or more processors and based at least in part on each test case step, a test case page image of one or more test case page images for the input image;
generating, using the one or more processors, the test case data entity based at least in part on the one or more test case page images; and
providing access, using the one or more processors, to the test case data entity, wherein the test case data entity is configured to enable execution of one or more software testing operations using an automated testing workflow data object associated with the test case data entity.

2. The computer-implemented method of claim 1, wherein the one or more action features for a particular test case step definition comprise a user action type for the test case step definition and a user-defined element label for the particular test case step definition.

3. The computer-implemented method of claim 1, wherein:
the ordered sequence of test case step definitions defines, for each test case step definition, a sequence number, and
the ordered sequence of test case step definitions is used to generate an ordered sequence of test case steps.

4. The computer-implemented method of claim 1, wherein providing access the test case data entity comprises generating a test case visualization user interface data object for a test case visualization user interface, wherein the test case visualization user interface enables presenting the plurality of test case page images.

5. The computer-implemented method of claim 4, wherein:
the test case visualization user interface enables presenting, overlaid on each test case page image, a visual element identifier for each test case step that is associated with the test case page image, and
each visual element identifier for a test case step is determined based at least in part on the visual element identifier location for the test case step definition that is associated with the test case step.

6. The computer-implemented method of claim 4, wherein the test case visualization user interface enables presenting, for each test case page image, a test case step action feature element for each test case step that is associated with the test case page image.

7. The computer-implemented method of claim 6, wherein each test case step action feature element is characterized by an element order that is determined based at least in part on a sequence order associated with the ordered sequence of test case step definitions.

8. The computer-implemented method of claim 1, wherein a sequence order associated with the ordered sequence of test case step definitions is determined based at least in part on a user annotations order associated with an ordered sequence of user annotations with respect to the input image.

9. An apparatus for generating a test case data entity, the apparatus comprising at least one processor and at least one memory including program code, the at least one memory and the program code configured to, with the processor, cause the apparatus to at least:
receive, originating from a client computing entity, an ordered sequence of one or more test case step definitions for an input image, wherein each test case step definition is associated with (i) a visual element identifier location within the input image, and (ii) one or more action features;
for each test case step definition, generate a test case step of an ordered sequence of test case step definitions based at least in part on the visual element identifier location for the test case step definition and the one or more action features for the test case step definition;
generate, based at least in part on each test case step, a test case page image of one or more test case page images for the input image;
generate the test case data entity based at least in part on the one or more test case page images; and
provide access to the test case data entity, wherein the test case data entity is configured to enable execution of one or more software testing operations using an automated testing workflow data object associated with the test case data entity.

10. The apparatus of claim 9, wherein the one or more action features for a particular test case step definition comprise a user action type for the test case step definition and a user-defined element label for the particular test case step definition.

11. The apparatus of claim 9, wherein:
the ordered sequence of test case step definitions defines, for each test case step definition, a sequence number, and
the ordered sequence of test case step definitions is used to generate an ordered sequence of test case steps.

12. The apparatus of claim 9, wherein providing access the test case data entity comprises generating a test case visualization user interface data object for a test case visualization user interface, wherein the test case visualization user interface enables presenting the plurality of test case page images.

13. The apparatus of claim 12, wherein:
the test case visualization user interface enables presenting, overlaid on each test case page image, a visual element identifier for each test case step that is associated with the test case page image, and
each visual element identifier for a test case step is determined based at least in part on the visual element identifier location for the test case step that is associated with the test case step.

14. The apparatus of claim 12, wherein the test case visualization user interface enables presenting, for each test case page image, a test case step action feature element for each test case step that is associated with the test case page image.

15. The apparatus of claim 14, wherein each test case step action feature element is characterized by an element order that is determined based at least in part on a sequence order associated with the ordered sequence of test case step definitions.

16. The apparatus of claim 9, wherein a sequence order associated with the ordered sequence of test case step definitions is determined based at least in part on a user annotations order associated with an ordered sequence of user annotations with respect to the input image.

17. A computer program product for generating a test case data entity, the computer program product comprising at least one non-transitory computer-readable storage medium having computer-readable program code portions stored therein, the computer-readable program code portions configured to:
receive, originating from a client computing entity, an ordered sequence of one or more test case step definitions for an input image, wherein each test case step definition is associated with (i) a visual element identifier location within the input image, and (ii) one or more action features;
for each test case step definition, generate a test case step of an ordered sequence of test case step definitions based at least in part on the visual element identifier location for the test case step definition and the one or more action features for the test case step definition;
generate, based at least in part on each test case step, a test case page image of one or more test case page images for the input image;
generate the test case data entity based at least in part on the one or more test case page images; and
provide access to the test case data entity, wherein the test case data entity is configured to enable execution of one or more software testing operations using an automated testing workflow data object associated with the test case data entity.

18. The computer program product of claim 17, wherein the one or more action features for a particular test case step definition comprise a user action type for the test case step definition and a user-defined element label for the particular test case step definition.

19. The computer program product of claim 17, wherein:
the ordered sequence of test case step definitions defines, for each test case step definition, a sequence number, and
the ordered sequence of test case step definitions is used to generate an ordered sequence of test case steps.

20. The computer program product of claim 17, wherein providing access the test case data entity comprises generating a test case visualization user interface data object for a test case visualization user interface, wherein the test case visualization user interface enables presenting the plurality of test case page images.
